(19) United States
(12) Patent Application Publication
(10) Pub. No.: US 2015/0370626 A1
(43) Pub. Date: Dec. 24, 2015

(54) RECORDING MEDIUM STORING A DATA MANAGEMENT PROGRAM, DATA MANAGEMENT APPARATUS AND DATA MANAGEMENT METHOD

(71) Applicant: FUJITSU LIMITED, Kawasaki-shi (JP)

(72) Inventors: Yukihisa Miyagawa, Tsushima (JP); Kiyoshi KOUGE, Kuwana (JP); Yasuhide Tobo, Chita (JP); Ichiro Kotani, Nagoya (JP); Takaaki Nakazawa, Nagoya (JP); Yuki Torii, Anjo (JP)

(73) Assignee: Fujitsu Limited, Kawasaki (JP)

(21) Appl. No.: 14/736,603

(22) Filed: Jun. 11, 2015

(30) Foreign Application Priority Data
Jun. 18, 2014 (JP) 2014-125703

(51) Int. Cl. G06F 11/07

(52) U.S. Cl. CPC G06F 11/0778; G06F 11/0709; G06F 11/0751; G06F 11/079

(57) ABSTRACT

A data management apparatus obtains first operation information about a specified operation from an information processing apparatus; specifies second operation information that matches a registered operation pattern from the first operation information, by utilizing operation pattern information that includes correspondence information between the specified operation and the registered operation pattern, the operation pattern information being stored in a first memory; obtains a second log from a first log of the information processing apparatus, the second log corresponds to time periods in which the specified operations that are not permitted by the registered operation pattern are done, the first log being stored in a second memory; and specifies a time period of a log extracted on the basis of a performance value indicated by the second log.

### CROSS-REFERENCE TO RELATED APPLICATION

This application is based upon and claims the benefit of priority of the prior Japanese Patent Application No. 2014-125703, filed on Jun. 18, 2014, the entire contents of which are incorporated herein by reference.

### FIELD

The embodiment discussed herein is related to data management.

### BACKGROUND

With the recent development of cloud technology and the like, the number of servers that manage the performance of a system has been increasing (to several thousand), and the amount of data accumulated in a performance database that stores observation data of system performance (hereinafter referred to as performance data) has been becoming enormous. For this reason, there has been a shortage of capacity of disks that accumulate data, and a disk cost has been increasing.

To reduce the amount of accumulated data, it is conceivable to decrease the amount of data by thinning out performance data having detailed content in accordance with a time period, a time zone or the like. However, at the time of troubleshooting when a performance trouble occurs, performance data of approximately one year past is needed. Accordingly, with uniform thinning out of performance data, performance data needed at the time of troubleshooting sometimes cannot be referenced, so that a caused problem cannot be recognized, or a considerable amount of time is needed to examine the problem.

A mechanism for enabling a reference of past performance data needed for troubleshooting while preventing a shortage in the capacity of a disc that accumulates data or an increase in a disc cost is needed.

As a first technique, a technique for reducing the amount of preserved data while acquiring needed data is presented (for example, Patent Document 1). With the first technique, an information preservation system including a device to be operated, connected via a network, and an information preservation device is implemented. The device to be operated determines whether a state change of the device is a preservation start instruction and a preservation end instruction of output data resulting from an operation performed on the basis of operation data, and transmits the output data, the preservation start instruction and the preservation end instruction. The information preservation device transmits operation data to the device to be operated, receives the output data, the preservation start instruction, and the preservation end instruction from the device to be operated, starts preserving the output data in accordance with the preservation start instruction, and ends the preservation of the output data in accordance with the preservation end instruction.

As a second technique, an abnormality detection technique that can efficiently detect in which data sequence an abnormality or a change occurs even when the number of data sequences is very large is implemented (for example, Patent Document 2). With the second technique, aggregation means aggregates data sequences that are determined to belong to the same group by calculating a sum of data values of the data sequences or a sum of powers of the data values. Statistic calculation means calculates a statistic of the data values of the data sequences before being aggregated. Group detection means detects a group including a data sequence in which an abnormality or a change occurs on the basis of a sum calculated for each group. Data sequence specifying means specifies a data sequence in which an abnormality or a change occurs on the basis of a statistic from among data sequences that belong to the group detected by the group detection means.

As a third technique, a data collection recording technique that collects data indicating a state of a system to be managed and holds the data for effective use is presented (for example, Patent Document 3). A data collection recording device includes a system data obtainment unit, a data recording unit, a data reading unit, a data compression unit, and a control unit. The system data obtainment unit obtains data of a state of a system to be managed at specified time intervals. The data recording unit records data in a data accumulation unit in a time series. The data reading unit reads the data recorded in the data accumulation unit. The data compression unit generates compressed data by executing a process for thinning out any of a plurality of pieces of data read by the data reading unit. The control unit controls the entire device. The data compression unit executes the process for thinning out any of the plurality of pieces of data so that a time interval of the data recorded in the data accumulation unit can become longer than a specified time interval. The data recording unit rewrites the data recorded in the data accumulation unit to compressed data.
Patent Document 1: Japanese Laid-open Patent Publication No. 2013-140471
Patent Document 2: Japanese Laid-open Patent Publication No. 2010-198579
Patent Document 3: Japanese Laid-open Patent Publication No. 2011-258064

### SUMMARY

A non-transitory computer-readable recording medium has stored therein a data management program for causing a computer to execute a process: obtaining first operation information about a specified operation from an information processing apparatus; specifying second operation information that matches a registered operation pattern from the first operation information, by utilizing operation pattern information that includes correspondence information between the specified operation and the registered operation pattern, the operation pattern information being stored in a first memory; obtaining a second log from a first log of the information processing apparatus, the second log corresponds to time periods in which the specified operations that are not permitted by the registered operation pattern are done, the first log being stored in a second memory; and specifying a time period of a log extracted on the basis of a performance value indicated by the second log.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example in a case where a performance problem is detected by using a related technique.

FIG. 2 is an explanatory diagram of a case where unneeded data is kept as a result of thinning out of data when a first technique is used.

FIG. 3 illustrates an example of a data management apparatus according to an embodiment.

FIG. 4 is a block diagram illustrating a monitoring system according to the embodiment.

FIG. 5A illustrates an example of OS reboot information in this embodiment, and FIG. 5B illustrates an example of OS reboot information (work table).

FIG. 6A illustrates stay-resident process list information in this embodiment, and FIG. 6B illustrates an example of stay-resident process list information (work table).

FIG. 7A illustrates an example of a VM resource allocation change pattern in this embodiment, and FIG. 7B illustrates an example of a VM resource allocation change pattern (work table).

FIG. 8 illustrates an example of a command list in this embodiment.

FIG. 9 illustrates an example of a reboot process list in this embodiment.

FIG. 10 illustrates an example of a module list in this embodiment.

FIG. 11 illustrates an example of a VM configuration list in this embodiment.

FIG. 12 illustrates a flow of the whole of a process in this embodiment.

FIGS. 13A-13C are explanatory diagrams of a thinning-out process in this embodiment.

FIG. 14 illustrates results after the process for thinning out performance data to be monitored as time elapses, in this embodiment.

FIG. 15 illustrates results after the process for thinning out performance data to be monitored as time elapses in units of weeks, in this embodiment.

FIG. 16 illustrates details of a flow of cycle information extraction (S1-1 (on an agent side)) of a periodical OS reboot, in this embodiment.

FIG. 17 illustrates details of a flow of the cycle information extraction (S1-1 (on a manager side)) of the periodical OS reboot, in this embodiment.

FIG. 18 illustrates details of a flow, at a first time, of a process (S1-2) (on the agent side) for extracting a stay-resident process list, in this embodiment.

FIG. 19 illustrates details of a flow, at and after a second time, of the process (S1-2) (on the agent side) for extracting a stay-resident process list, in this embodiment.

FIG. 20 illustrates details of a flow at the termination of a monitoring period of the process (S1-2) (on the manager side) for extracting a stay-resident process list, in this embodiment.

FIG. 21 illustrates details of a flow of cycle information extraction (S1-3) of a periodical dynamic change of a resource in a virtual environment, in this embodiment.

FIG. 22 illustrates details of a flow at the termination of the monitoring period of the cycle information extraction (S1-3) (on the manager side) of the periodical dynamic change of the resource in the virtual environment, in this embodiment.

FIG. 23 illustrates details of a flow of a process (S2-1) for detecting an OS reboot, in this embodiment.

FIG. 24 illustrates details of a flow of a process (S3-1) for determining a periodical OS reboot, in this embodiment.

FIG. 25 illustrates details of a flow of a process (S2-2) for detecting a reboot of middleware or an application, in this embodiment.

FIG. 26 illustrates details of a flow of a process (S3-2) for determining a reboot of middleware of an application program by applying a revision/modification program, in this embodiment.

FIG. 27 illustrates details of a flow of a process (S2-3) for detecting a performance information obtainment system command periodically executed by a server to be monitored, in this embodiment.

FIG. 28 illustrates details of a flow of a process (S3-3) for determining whether a command is a performance information obtainment system command periodically executed by the server to be monitored in this embodiment.

FIG. 29 illustrates details of a flow of a process (S2-4) for detecting a dynamic change of a resource in a virtual environment, in this embodiment.

FIG. 30 illustrates details of a flow of a process (S3-4) for determining whether a dynamic change of a resource in a virtual environment is a periodical dynamic change, in this embodiment.

FIG. 31 illustrates details of a flow of a process (S2-5) for detecting a live migration in a virtual environment, in this embodiment.

FIG. 32 illustrates details of a flow of a process (for a first time) (S3-4) for determining whether a live migration is caused by a problem other than that of a target system, in this embodiment.

FIG. 33 illustrates details of a flow of a process (at and after a second time) (S3-4) for determining whether a live migration is caused by a problem other than that of a target system, in this embodiment.

FIG. 34 illustrates details of a flow of a process (S3-5-6) for detecting whether a live migration performed for a reason other than a problem of the target system is present, in this embodiment.

FIG. 35 illustrates details of a flow (No. 1) of a process for specifying a starting point and an end point of a time period in which performance data exceeds a range of a standard deviation in the process (S4) for thinning out performance data in a normal state from performance data stored in a performance information DB, in this embodiment.

FIG. 36 illustrates details of a flow (No. 2) for specifying the starting point and the end point of the length of time in which the performance data exceeds the range of the standard deviation in the process (S4) for thinning out the performance data in the normal state from the performance data stored in the performance information DB, in this embodiment.

FIG. 37 illustrates details of a flow of the process (S4) for thinning out the performance data in the normal state from the performance data stored in the performance information DB on the basis of the specified starting point and end point, in this embodiment.

FIG. 38 illustrates a flow of a process for referencing performance data, in this embodiment.

FIG. 39 illustrates a flow of a process for deleting unreferenced performance data, in this embodiment.

FIG. 40 illustrates an example of a configuration block diagram of a hardware environment of a computer that executes a program in this embodiment.

### DESCRIPTION OF EMBODIMENT

Past performance data needed at the time of troubleshooting is data used when a performance problem occurred in the past. Therefore, an approach in which a portion of performance data is kept when the performance problem occurred and the other portion is thinned out as unneeded data is conceivable. A technique for monitoring a threshold value and a technique for detecting symptoms are conceivable as related techniques for automatically detecting an occurrence of a performance problem. However, these techniques have unsolvable problems.

With the technique for monitoring a threshold value, a user monitors a system by setting a threshold value for each monitoring entry of the system, and an alarm is issued when a measured value of the monitoring entry exceeds the threshold value.

However, there is a problem such that an abnormality that does not need to be reported, in accordance with an operational state or a time zone, is reported, or an abnormality that needs to be reported is not reported.

With the technique for detecting symptoms, whether an operation of the system is either normal or abnormal is determined by statistically processing measured values of system performance. In this way, an abnormality that is not learned from individually measured values can be found with a statistical computation.

However, even if it is determined that a certain piece of data is abnormal in accordance with values of the statistical computation and the abnormality is reported to a user, the data may actually not be needed as data for analyzing a cause due to a temporary tendency to exhibit such an abnormality in many cases. Moreover, since a system configuration and resource allocations are made dynamically changeable in a cloud environment, an accuracy with which an abnormal value (outlier) is detected from past performance data is degraded.

Namely, a control for data to be accumulated by monitoring a threshold value or detecting symptoms poses a problem such that performance data in a time zone where an abnormality occurs cannot be kept from among performance data of a system in which the abnormality occurs, or performance data in a time zone where an abnormality does not occur is kept.

One aspect of the present invention provides a technique for extracting a log corresponding to a time period in which an abnormality occurs from an accumulated log to be monitored.

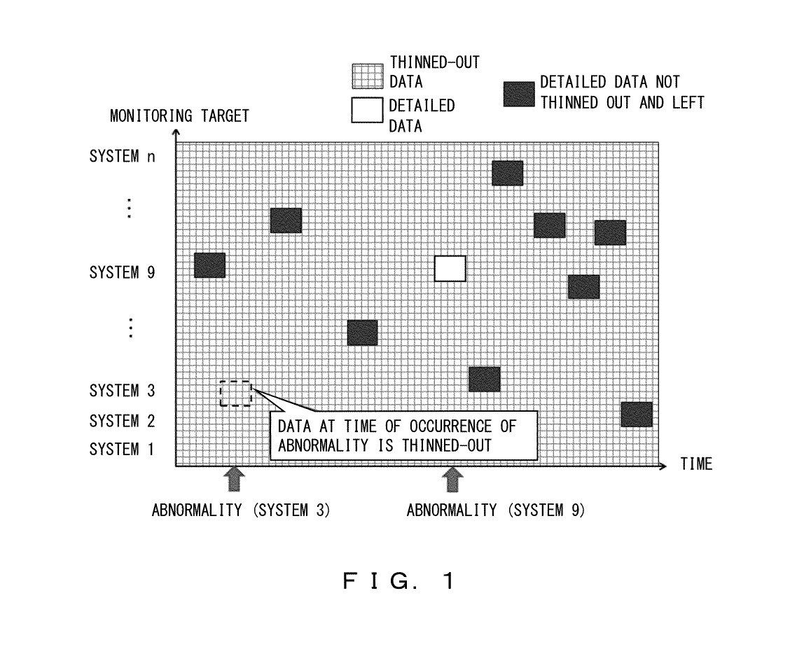

FIG. 1 is an explanatory diagram of an example for detecting a performance problem by using a related technique. In FIG. 1, a vertical axis indicates systems to be monitored, and a horizontal axis indicates time.

“abnormality (system 3)” in FIG. 1 represents a state where performance data to be accumulated is thinned out and not kept with the above described related technique. “abnormality (system 9)” in FIG. 1 represents a state where performance data to be accumulated is properly kept.

Systems other than “abnormality (system 3)” and “abnormality (system 9)” represent a state where many temporary alerts that do not matter in terms of operations occur and many pieces of performance data are not thinned out and kept.

When the amount of data is reduced, a reduction method using a file compression technique is also conceivable. However, this method is excluded because of the following problem.

A technique (such as ZIP) of reversible data compression (guaranteeing that original data is restored to exactly the same data) implements a compression rate of approximately one tenth, and a very large number of discs (several TBs or more) are needed to accumulate the details of one year of performance data of several thousands of servers to be managed that is aggregated at a data center.

A technique (such as JPEG) of highly compressive irreversible compression (which does not guarantee that original data will be restored to the same data) implements a high compression rate. However, values of detailed performance data cannot be exactly restored. As a result of the compression, for example, a data value is restored to 0 in a case where the data value is other than 0, or the value is restored to a value larger than 0 in a case where the value is 0. Accordingly, the compressed data is unavailable at the time of troubleshooting.

Additionally, when performance data is compressed by using a compression technique, data needs to be restored at the time of troubleshooting. When the amount of data becomes large, a restoration time increases and the data becomes unavailable for urgent troubleshooting. Moreover, a problem of the capacity of a disk for temporarily restoring a large amount of data is posed.

Furthermore, when performance trouble occurs, an operator performs a certain operation for an IT (Information Technology) system, such as a collection of examination materials, or a reboot for working around the trouble, or the like. Accordingly, a technique for detecting an occurrence of performance trouble by utilizing this characteristic to catch up with an operation that an operator performs on a terminal for the IT system is conceivable. A technique for catching up with an operation performed on a terminal, and for implementing a preservation operation for data by specifying content of the operation, is presented (for example, the first technique).

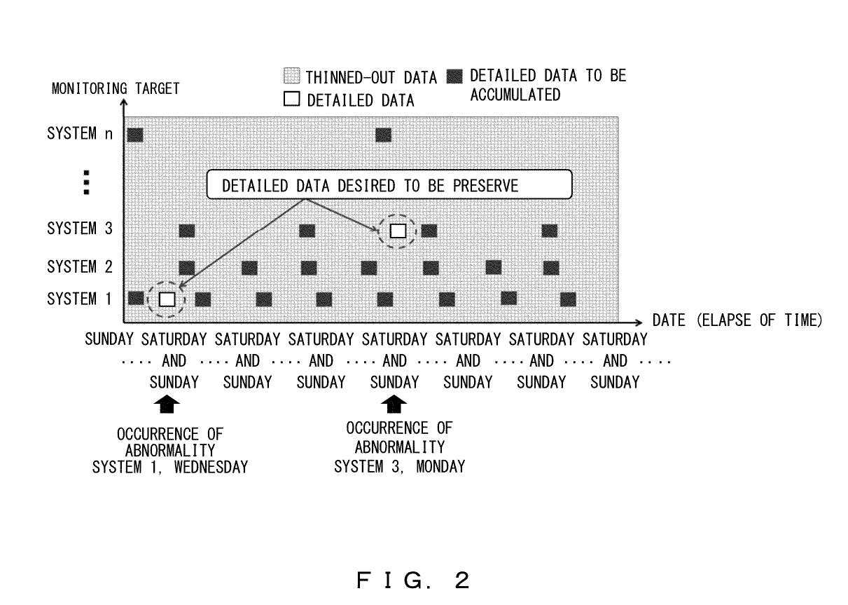

FIG. 2 is an explanatory diagram of a case where unneeded data is kept as a result of thinning out of data when the first technique is used. In FIG. 2, a vertical axis indicates systems to be monitored, whereas a horizontal axis indicates time.

In the case illustrated in FIG. 2, the following periodical reboot is performed in each of the systems.

system 1: every Sunday, system 2: every Saturday

system 3: every other Saturday, system n: every first Sunday

However, when attempts are made to solve the problem by using the first technique, a performance trouble is erroneously recognized to occur each time a periodical reboot operation is performed, for example, every weekend, and unneeded data (performance data to be accumulated) is preserved.

Accordingly, in this embodiment, whether a problem has occurred is determined by using a characteristic of an operation that a system administrator performs for a system when the performance problem has occurred, and needed performance data is kept when it is determined that the operation is the one performed when a problem has occurred.

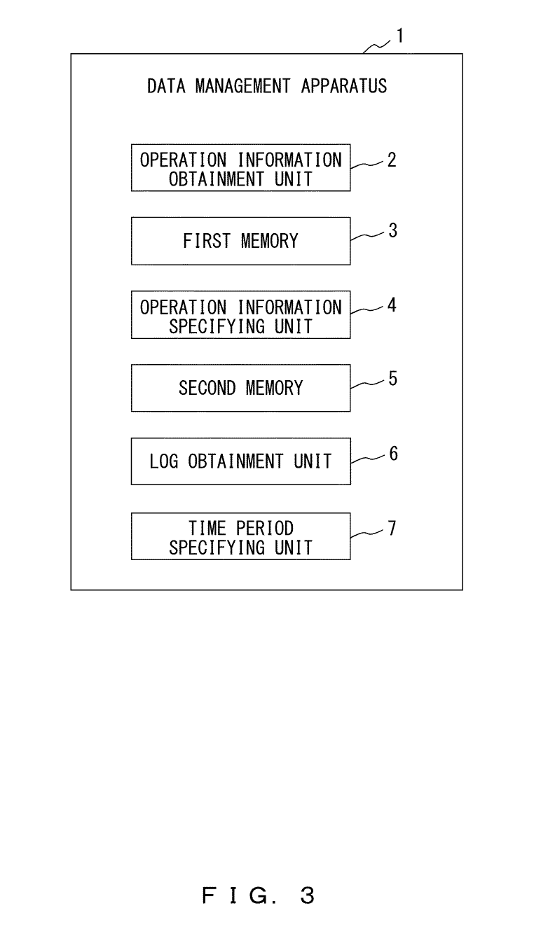

FIG. 3 illustrates an example of a data management apparatus according to this embodiment. The data management apparatus 1 includes an operation information obtainment unit 2, a first memory 3, an operation information specifying unit 4, a second memory 5, a log obtainment unit 6, and a period specifying unit 7.

The operation information obtainment unit 2 obtains first operation information about a specified operation from an information processing apparatus. As an example of the operation information obtainment unit 2, a detection unit 18 is cited. As an example of the information processing apparatus, a host server 42 or a virtual server 43 of a server 41 is cited.

The first memory 3 operation pattern information that includes correspondence information between the specified operation and the registered operation pattern. As an example of the first memory 3, a management DB 23 is cited.

The operation information specifying unit 4 specifies second operation information that matches a registered operation pattern from the first operation information by utilizing the operation pattern information. As an example of the operation information specifying unit 4, a decision unit 19 is cited.

The second memory 5 stores a log of the information processing apparatus. As an example of the second memory 5, a performance information DB 22 that stores performance data is cited.

The log obtainment unit 6 obtains a second log from a first log of the information processing apparatus, the second log corresponds to time periods in which the specified operations that are not permitted by the registered operation pattern are done. The first log is stored in a second memory. As an example of the log obtainment unit 6, a thinning-out unit 20 is cited.

The period specifying unit 7 specifies a time period of a log extracted on the basis of a performance value indicated by the second log. As an example of the period specifying unit 7, the thinning-out unit 20 is cited.

With this configuration, a log corresponding to a time period in which an abnormality occurs can be extracted from an accumulated log to be monitored.

The period specifying unit 7 specifies a log of a time period in which the performance value indicated by the obtained second log deviates from a specified range. Namely, the log obtainment unit 6 obtains, from the second memory 5, the second log that matches a date on which information of an unpermitted second operation information is registered in the registered operation pattern. At this time, the period specifying unit 7 calculates a standard deviation of the performance value indicated by the obtained second log, and specifies a log corresponding to the time period in which the performance value deviates from the standard deviation.

With this configuration, performance data of a time period in an abnormal state can be extracted from performance data, including an occurrence of an abnormality.

The period specifying unit 7 calculates an average of performance values of a log present for a specified length of time before a time period in which a performance value deviates from a range of the standard deviation, and specifies the log of the averaged performance value.

With this configuration, performance data immediately before an abnormality occurs can be extracted.

Here, the operation pattern information is pattern information about a reboot of a specified program in the information processing apparatus, a specified command issued to the information processing apparatus, a change of a resource in the information processing apparatus, or a migration of a virtual environment of a virtual machine in a case where the information processing apparatus is the virtual machine.

With this configuration, an operation performed at a normal time, such as a periodically performed operation or the like, can be distinguished from that actually performed at the time of an abnormality by using pattern information.

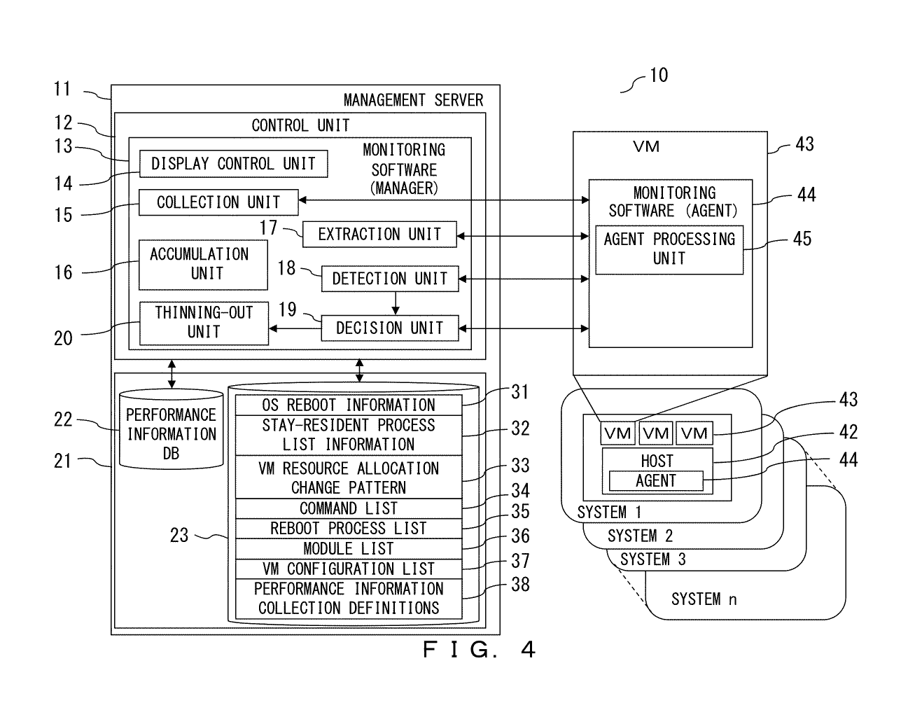

FIG. 4 is a block diagram illustrating a monitoring system in this embodiment. The monitoring system 10 includes a management server 11, and one or more servers 41. The management server 11 and the one or more servers 41 are interconnected by a communication network.

Each of the servers 41 is a server included in a system (1, 2, . . . , n) that runs in a physical server. Specifically, each of the servers 41 includes a server (a host server or a physical server) 42 based on a host OS (Operating System), and a server (a virtual server) 43 based on a guest OS running on a virtual machine (VM).

A host environment of the host server (physical server) 42 is an environment virtualized with a virtualization technique. In the host environment, a plurality of VMs run. Accordingly, an OS can be made to run in each of the VMs (guest environments) with the virtualization technique. In this way, a virtual server (VM) runs in each guest environment.

In each of the servers (the physical servers and the VMs) 41, monitoring software (an agent) 44 is installed. The monitoring software (agent) 44 includes an agent processing unit 45. The agent processing unit 45 collects information about performance data of an operation and a specified operation, and other items of information, by recognizing as a monitoring target the server 41 in which the target agent processing unit 45 is installed, and transmits the collected information to the monitoring software (manager) 13.

The management server 11 monitors the one or more servers 41, and obtains and accumulates measured information (performance data such as a memory use rate, a CPU use rate and the like) by monitoring the performance of the server 41 at each time. The management server 11 includes a control unit 12 and a memory 21. The memory 21 includes the performance information DB 22 (a database is hereinafter abbreviated to “DB”) and the management DB 23.

The performance information DB 22 stores time-series performance data of operations of each of the servers to be monitored 41 by monitoring each of the servers to be monitored 41.

The management DB 23 stores OS reboot information 31, stay-resident process list information 32, a command list 33, a reboot process list 34, a module list 35, a VM resource allocation change pattern 36, a VM configuration list 37, performance information collection definitions 38, and the like.

The OS reboot information 31 represents information about the timing of a periodical OS reboot of the server to be monitored 41. The stay-resident process list information 32 is information about a process that stays resident in the server to be monitored 41. The VM resource allocation change pattern 33 is information about an operation for allocating a resource for each VM. The command list 34 includes performance information obtainment system commands (top, ps, vstat and the like). The reboot process list 35 is information of a list about processes rebooted in a halt state. The module list 36 is information of a list that manages modules when a product or a revised module is installed. The VM configuration list 37 includes configuration information of VMs present within a system (host server). The performance information collection definitions 38 include definitions for collecting performance data.

Additionally, work tables of the OS reboot information 31, the stay-resident process list information 32, and the VM resource allocation change pattern 33 are formed in a memory as a process proceeds.

The control unit 12 functions as a display control unit 14, a collection unit 15, an accumulation control unit 16, an extraction unit 17, the detection unit 18, the decision unit 19, and the thinning-out unit 20 by reading, from the memory 21, monitoring software (manager) 13 including a program according to this embodiment, and by executing the program.

The display control unit 14 performs a control for displaying results of monitoring the server to be monitored 41 on a display unit (not illustrated). The collection unit 15 collects results of monitoring from the servers to be monitored 41 on the basis of the performance information collection definitions 38. The accumulation control unit 16 stores, in the performance information DB 22, results of monitoring collected from the servers to be monitored 41.

The extraction unit 17 collects various items of information from the server to be monitored 41 by monitoring the server to be monitored 41 for a certain time period, and extracts, from the collected information, information used to detect a specified operation among operations of a user. The information used to detect a specified operation is, for example, event log/system log information obtained from each of the servers to be monitored 41, a process list, a log of a Hypervisor, and the like.

The detection unit 18 detects an operation performed when a performance problem occurs from the information extracted by the extraction unit 17.

The decision unit 19 determines whether the operation detected by the detection unit 18 has been used for a purpose other than a purpose of being used when a performance problem occurs, and specifies an operation used only when the performance problem occurs.

The thinning-out unit 20 obtains performance data of a time period of the operation specified by the decision unit 19, thins out (deletes) data having a performance value indicating that the obtained performance data is within a specified range, and obtains the remaining data (performance data corresponding to a time period that deviates from the specified range). Namely, the thinning-out unit 20 extracts the performance data corresponding to the time period in which the performance value indicated by the obtained performance data deviates from the specified range.

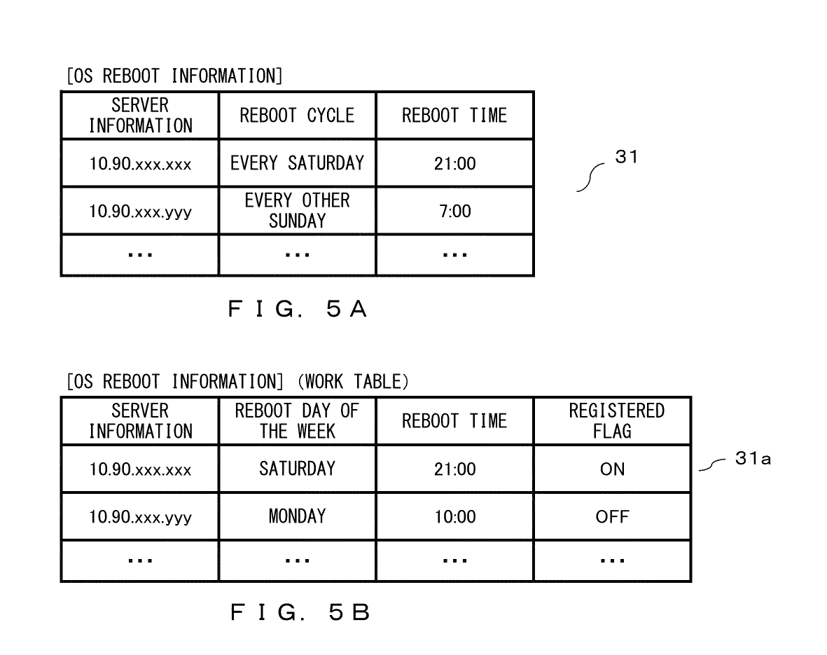

FIG. 5A illustrates an example of OS reboot information in this embodiment. FIG. 5B illustrates an example of OS reboot information (worktable). The OS reboot information 31 illustrated in FIG. 5A includes data entries such as “server information”, a “reboot day of the week”, and a “reboot time”.

In the server information, information for specifying a server, such as an IP (Internet Protocol) address or the like, is stored. In the “reboot day of the week”, a day of the week on which the server is rebooted is stored. In the “reboot time”, a time at which the server is rebooted is stored.

The OS reboot information (work table) 31a illustrated in FIG. 5B is a table temporarily created during the process, and a data entry “registered” is added to the OS reboot information 31. The “registered” is set to OFF (unregistered) as an initial value, or set to ON (registered) if the same record is already registered when a record is newly registered in the OS reboot information (work table) 31a.

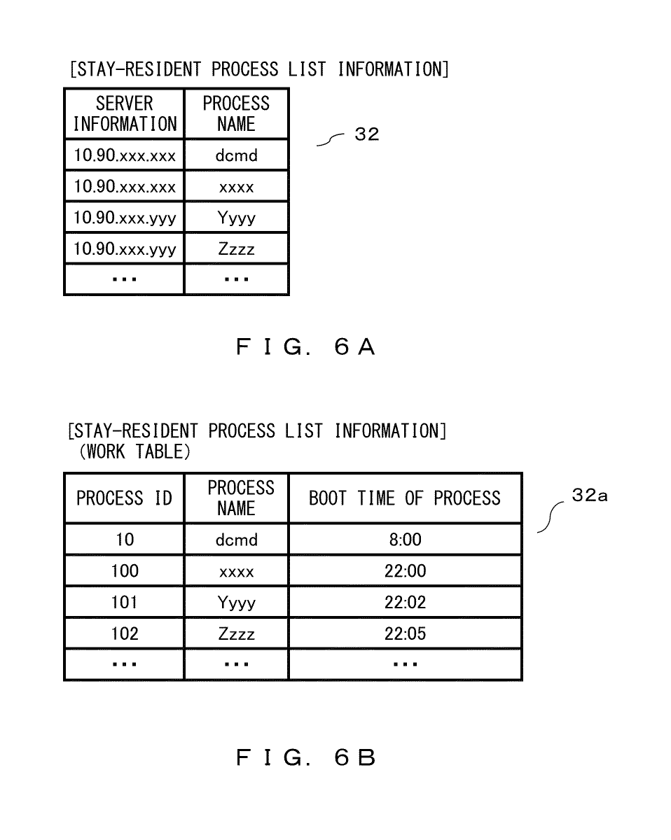

FIG. 6A illustrates an example of the stay-resident process list information in this embodiment. FIG. 6B illustrates an example of the stay-resident process list information (work table). The stay-resident process list information 32 illustrated in FIG. 6A includes “server information” and a “process name”. In the “server information”, information for specifying a server, such as an IP address or the like, is stored. In the “process name”, a name of a process is stored.

The stay-resident process list information (work table) 32a illustrated in FIG. 6B is a table temporarily created during the process, and data entries such as a “process ID”, a “process name”, and a “process boot time” are stored.

In the “process ID”, information for specifying a process is stored. In the “process name”, a name of the process is stored. In the “process boot time”, a time at which the process is booted is stored.

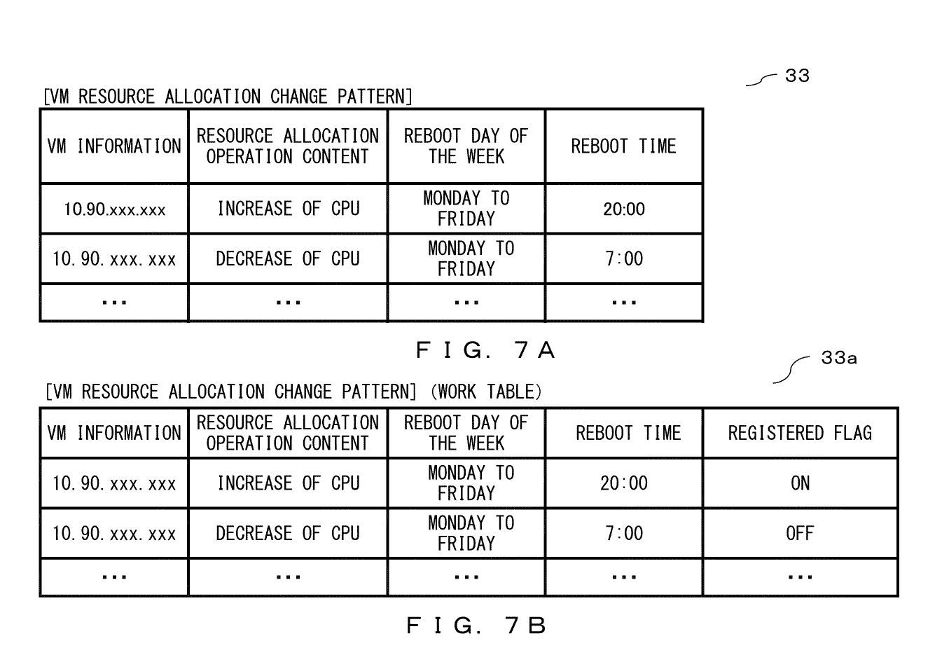

FIG. 7A illustrates an example of the VM resource allocation change pattern in this embodiment. FIG. 7B illustrates an example of the VM resource allocation change pattern (work table). The VM resource allocation change pattern 33 includes data entries such as “VM information”, a “resource allocation operation content”, a “reboot day of the week”, and a “reboot time”.

In the “VM information”, information for specifying a virtual machine, such as an IP address or the like of a virtual server (VM), is stored. In the “resource allocation operation content”, content of an operation for allocating a resource to a virtual machine, such as an increase or decrease in an allocation of a CPU to a VM, or the like, is stored. In the “reboot day of the week”, a day of the week on which a VM is rebooted is stored. In the “reboot time”, a time at which the virtual server is rebooted is stored.

The VM resource allocation change pattern (work table) 33a illustrated in FIG. 7B is a table temporarily created during the process, and a data entry “registered” is added in the OS reboot information 31. The “registered” is set to OFF (unregistered) as an initial value, or is set to ON (registered) if the same record is already registered when a record is newly registered in the VM resource allocation change pattern (work table) 33a.

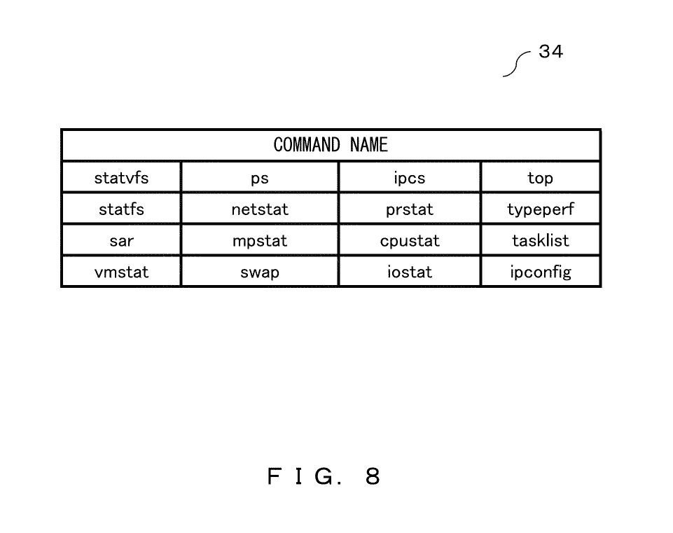

FIG. 8 illustrates an example of the command list in this embodiment. In the command list 34, performance information obtainment system commands (top, ps, vstat and the like) are stored.

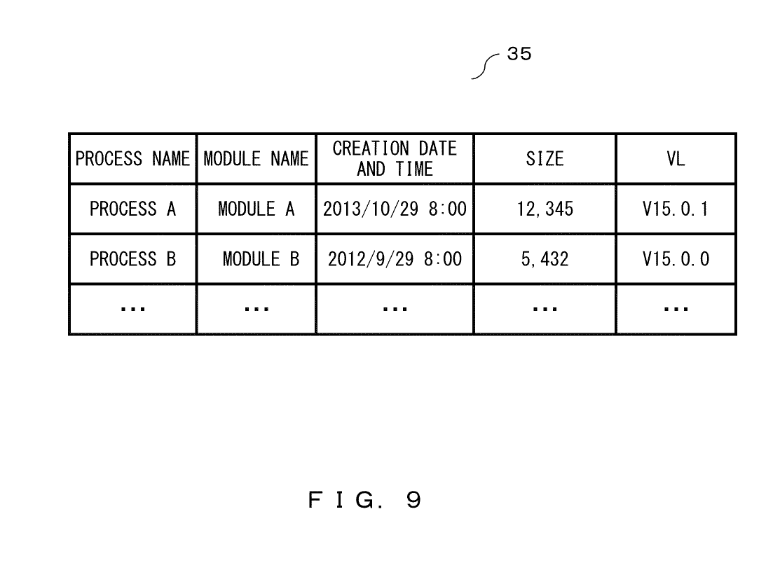

FIG. 9 illustrates an example of the reboot process list in this embodiment. The reboot process list 35 represents a list of processes rebooted in a halt state. The reboot process 35 includes data entries such as a “process name”, a “module name”, a “creation date and time”, a “size”, and “VL”.

In the “process name”, a name of a process rebooted in a halt state is stored. In the “module name”, a name of a module used in the process is stored. In the “creation date and time”, a creation date and time of the module is stored. In the “size”, a size of the module is stored. In the “VL”, a revision number (version) of the module is stored.

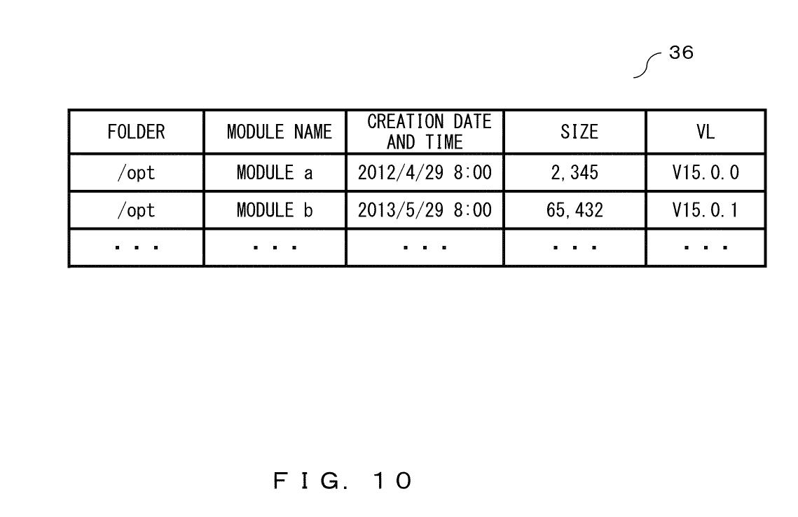

FIG. 10 illustrates an example of the module list in this embodiment. The module list 36 represents a list that manages modules used when a product or a revised module is installed. The module list 36 includes data entries such as a “folder”, a “module name”, a “creation date and time”, a “size”, and “VL”.

In the “folder”, a storage destination of a module is stored. In the “module name”, a name of the module is stored. In the “creation date and time”, a creation date and time of the module is stored. In the “size”, a size of the module is stored. In the “VL”, a revision number (version) of the module is stored.

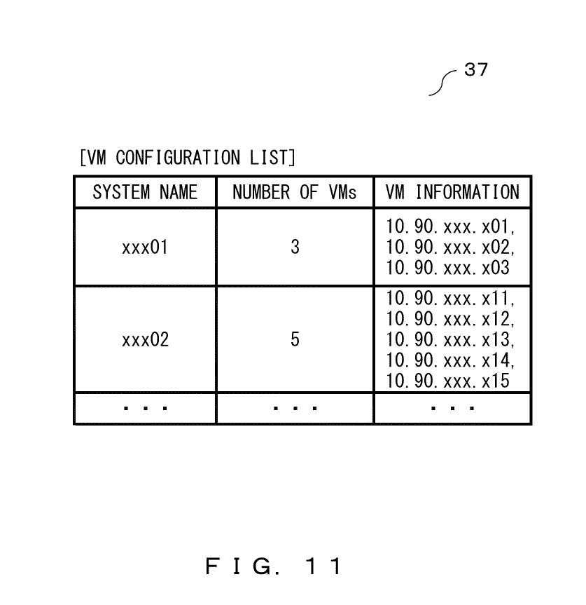

FIG. 11 illustrates an example of the VM configuration list in this embodiment. The VM configuration list 37 represents a list of virtual servers (VMs) that configure each system. The VM configuration list 37 includes data entries such as a “system name”, “the number of VMs”, and “VM information”.

In the “system name”, a name of a system is stored. In the “the number of VMs”, the number of VMs that run in the system is stored. In the “VM information”, information for specifying a virtual machine, such as an IP address or the like of a VM, is stored.

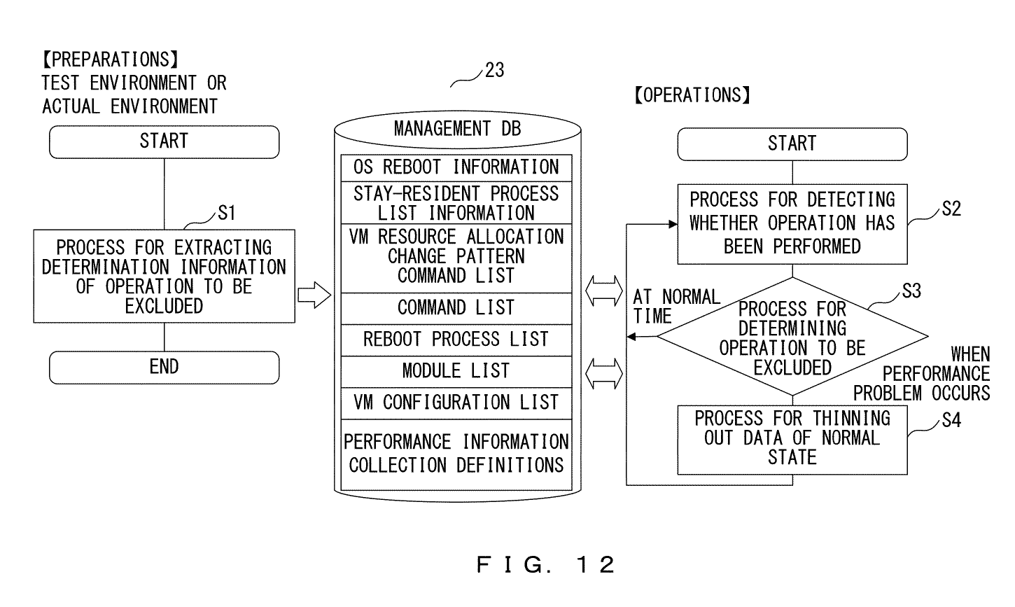

FIG. 12 illustrates a flow of the entire process in this embodiment. Initially, operation-to-be-excluded determination information extraction (monitoring in a test environment or an actual environment) is performed as a preparatory process in the test environment or the actual environment (S1). In S1, the agent processing unit 45 monitors a business operation server for a certain time period (such as one month) in the test environment or the actual environment (in a case where a test environment is not present), generates information used in S3 to be described later, and transmits the generated information to the management server 11.

Examples of the information generated in S1 include cycle information of a periodical OS reboot, a stay-resident process list, and cycle information of a periodical dynamic change of a resource in a virtual environment as follows.

(S1-1) Cycle information extraction of a periodical OS reboot

The agent processing unit 45 obtains information for specifying the timing of an OS reboot from event log/system log information of each of the servers to be monitored 41 in the server 41 during a monitoring period of the server 41.

The agent processing unit 45 derives a pattern of a cycle and a time from a plurality of OS reboot timings (dates and times) obtained from the event log/system log information of the server during the monitoring period, and creates the OS reboot information 31 (FIG. 5A).

(S1-2) Extraction of a stay-resident process list

The agent processing unit 45 obtains a process list at specified time intervals (such as 10-minute intervals) in each of the servers 41 during the monitoring period. The agent processing unit 45 saves process information (a process ID, a process name, and a process boot time) in the stay-resident process list information (work table) 32a (FIG. 6B) in accordance with the obtained process list. The agent processing unit 45 saves all pieces of process information in the stay-resident process list information (work table) 32a when the process list is initially obtained.

The agent processing unit 45 executes the following process when it obtains a process list at and after the second time. Namely, the agent processing unit 45 adds information of a process that is not present in the stay-resident process list information (work table) 32a to the stay-resident process list information (work table) 32a. Alternatively, the agent processing unit 45 executes no process for a process that is present in the stay-resident process list information (work table) 32a and present also in the process list obtained at this time. Further alternatively, the agent processing unit 45 makes a comparison between a boot time of the process and the current time for a process that is present in the stay-resident process list information (work table) 32a and not present in the process list obtained at this time. When the comparison shows that the process is a process that is present, by way of example, for less than four hours, the agent processing unit 45 deletes the process information from the stay-resident process list information (work table) 32a.

Next, the agent processing unit 45 saves the process information list kept in the stay-resident process list information (work table) 32a in the stay-resident process list information 32 (FIG. 6A) at the termination of the monitoring period.

(S1-3) Cycle information extraction of a periodical dynamic change of a resource (a CPU, a memory or the like) in a virtual environment.

The extraction unit 17 obtains resource allocation operation information for a VM from a log of a hypervisor in each Hypervisor (a server that manages a virtual environment) during the monitoring period.

The extraction unit 17 derives a pattern of content, a day of the week, and a time of a resource operation from a plurality of pieces of resource allocation operation information obtained during the monitoring period, and creates the VM resource allocation change pattern 33 (FIG. 7A).

Next, it is detected as a monitoring process in the actual environment whether an operation performed when a performance problem occurs has been performed (S2). Here, a system administrator performs the following operation when the performance problem occurs.

(S2-1) A temporary workaround action: a reboot of an OS
(S2-2) A temporary workaround action: a reboot of middleware or an application
(S2-3) A performance information obtainment action: execution of a command (top, ps, vstat or the like)
(S2-4) A dynamic change (an addition or a deletion) of a resource (a CPU or a memory) in a virtual environment
(S2-5) A live migration in a virtual environment

The operations of (S2-1) to (S2-5) can be detected with the following method.

(S2-1) Information about a reboot of an OS (S2-1) can be detected from an event log/system log by the detection unit 18.

(S2-2) A reboot of middleware or an application can be detected from the event log/system log by the detection unit 18.

(S2-3) Issuance of a command (execution of a command) can sometimes be verified according to a log of an OS or the like. However, information of all commands cannot be verified. Accordingly, the detection unit 18 creates the command list 34 of performance information obtainment system commands (top, ps, vstat and the like), specifies a process, and detects the issuance of a command.

(S2-4) A dynamic change of a resource (a CPU or a memory) in a virtual environment can be detected from a log of virtualization software (VMware or the like) by the detection unit 18.

(S2-5) Alive migration in a virtual environment can be detected from a log of virtualization software.

Next, an operation to be excluded is determined (S3). An operation for the server to be monitored 41 when a performance problem occurs is sometimes performed for “another purpose” other than a purpose of ensuring, verifying, and restoring an occurrence of a performance problem. Accordingly, in S3, the decision unit 19 specifies an operation performed when a performance problem occurs (at an abnormal time) by excluding the following operations performed at normal times for “another purpose” from among operations performed for the server 41.

(S3-1) A periodical reboot of an OS
(S3-2) A reboot of middleware or an application program by applying a revision/modification program
(S3-3) A performance information obtainment system command periodically executed by a server to be monitored
(S3-4) A periodical dynamic change of a resource (a CPU or a memory) in a virtual environment
(S3-5) A live migration performed for a reason other than a problem of a target system

The above described operations performed for “another purpose” can be verified with the following method.

(S3-1) The decision unit 19 makes a comparison between the information, detected in S2-1, about an OS reboot in the actual environment and the OS reboot information 31 created during the monitoring period. Then, the decision unit 19 can determine that the OS reboot, detected in S2-1, in the actual environment is a periodical OS reboot when the reboot day of the week and the reboot time of the server 41 match those of the OS reboot information 31. Here, it is assumed that a time difference of plus or minus one hour is recognized as a “match”.

(S3-2) According to content of the reboot detected from the event log/system log, the decision unit 19 cannot determine whether the reboot is caused by applying a revision/modification program. Accordingly, the decision unit 19 creates the reboot process list 35 (FIG. 9) for the rebooted process. The decision unit 19 determines whether the revision/modification program is applied at this time by making a comparison between the creation date and time, the size and VL of the reboot process list 35 and those of the module list 36 (FIG. 10) created when the product is installed or the revision/modification program released at preceding time is applied. Note that the creation date, the size and the VL of the module list are updated after the revision/modification program is applied.

(S3-3) The decision unit 19 makes a comparison between information of the process list, obtained in the actual environment, of each of the servers 41 and that of the stay-resident process list information 32 created during the monitoring period. When the process names of the server match in the lists, the decision unit 19 can determine that the command is a performance information obtainment system command periodically executed by the server to be monitored 41.

(S3-4) The decision unit 19 makes a comparison between VM resource allocation change information, obtained in the actual environment, of each of the servers 41 and the VM resource allocation change pattern 33 created during the monitoring period. When the resource allocation operation content, the operation day of the week, and the time of the VM in the information match those of the VM resource allocation change pattern 33, the decision unit 19 can determine that the command is a periodical dynamic change of a resource in a virtual environment. Here, it is assumed that a time difference of plus or minus one hour is recognized as a “match”.

(S3-5) Alive migration can be verified in accordance with a log of virtualization software. Configuration information of each system can be obtained with a configuration information obtainment command of virtualization software. However, whether the timing at which the migration occurs is caused either by a system at a migration source or that at a migration destination cannot be determined only in accordance with the log.

Therefore, the decision unit 19 verifies both a change of the VM configuration list 37 that is collected periodically and configures the system and performance data of resources, and determines whether a performance abnormality such as a high load or the like occurs when a migration is caused. In this way, whether the live migration is caused either by a performance abnormality of the target system or by a problem (such as a performance abnormality of another system, maintenance or the like) other than that of the target system can be determined.

When it is determined from the comparison made in S3 that the operation performed in S2 is an operation performed when a performance problem actually occurs, the process of S4 is executed. When it is determined that the operation performed in S2 is not the one performed when a performance problem actually occurs as a result of the comparison made in S3, namely, when it is determined that the operation performed in S2 is the one performed at a normal time, the flow returns to the process of S2.

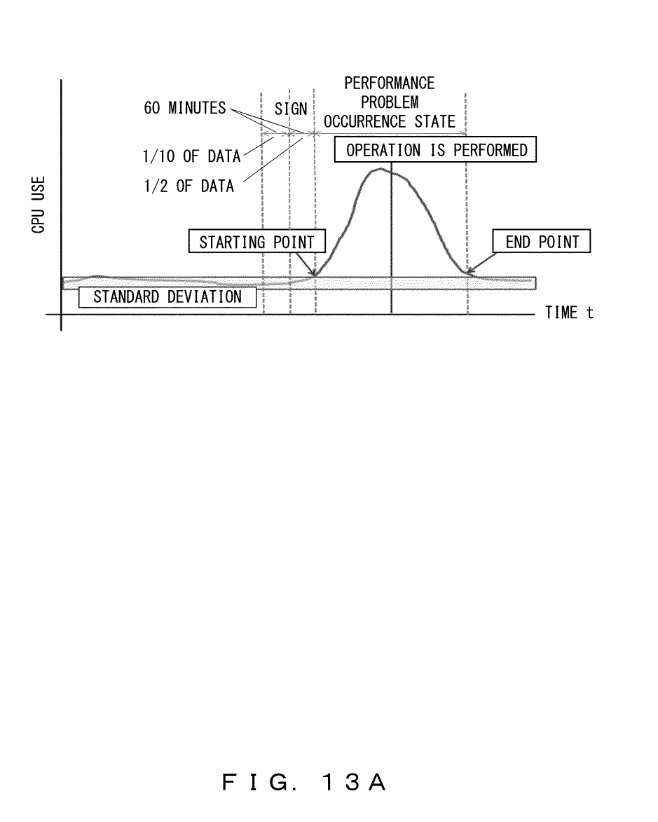

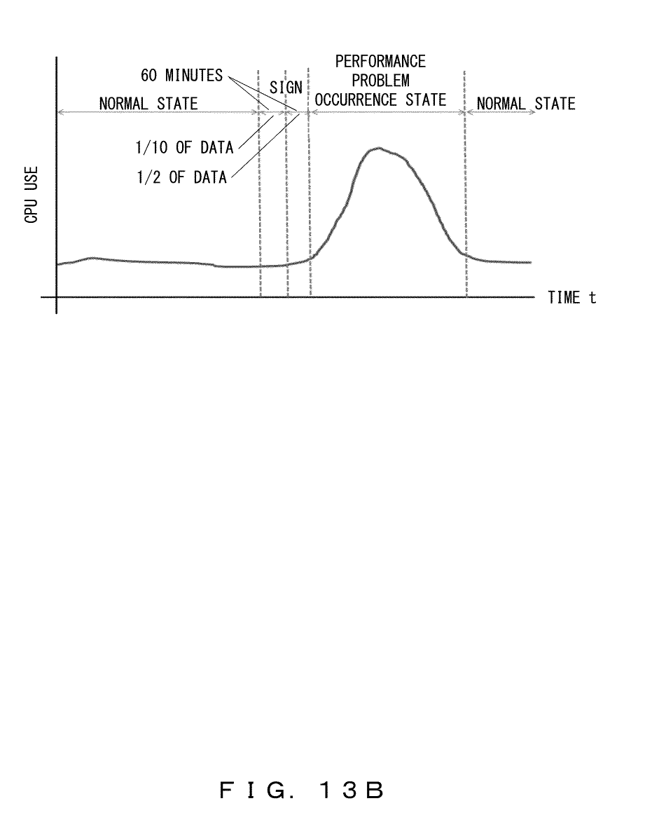

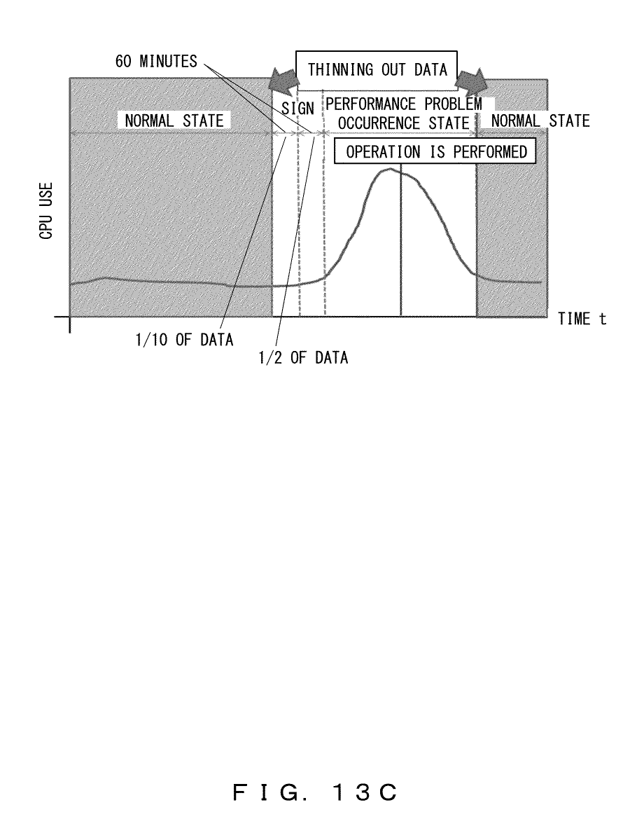

Next, performance data in a normal state is thinned out from performance data accumulated in the performance information DB 22 (S4). S4 will be described with reference to FIGS. 13A-13C.

FIGS. 13A-13C are explanatory diagrams of a thinning-out process executed in this embodiment. Operations other than (S3-1) to (S3-5) among operations (S2-1) to (S2-5) are defined as “operations performed when a performance problem occurs” (hereinafter referred to as a “performance problem occurrence state”). Data of the “performance problem occurrence state” can be decided as follows.

(A) The thinning-out unit 20 specifies a business operation system to which a server belongs in accordance with configuration information on the basis of information of the server in which the operation of the “performance problem occurrence state” is performed. The thinning-out unit 20 determines all servers and other appliances (if they exist) that configure the business operation system to be target data of the “performance problem occurrence state”.
(B) As illustrated in FIG. 13A, the thinning-out unit 20 calculates a point at which performance data starts to deviate from a range of a standard deviation respectively for all performance data entries by going back to the past, and defines performance data of the oldest date and time as a “starting point”. Here, the range of the standard deviation indicates a range of an average value μ± standard deviation σ.

However, it is necessary to verify a state before the “starting point” as a “symptom” of a phenomenon depending on the phenomenon. Accordingly, the thinning-out unit 20 converts (averages), for example, performance data 60 minutes before the “starting point” into one half of the amount of data, also converts (averages) data an additional 60 minutes before the preceding point into one tenth of the amount of data, and leaves the averaged data. Note that the compression rates of the data are merely examples, and are not limited to the values of one half and one tenth.

(C) The thinning-out unit 20 obtains, as an “end point”, a point at which the performance data returns to the range of the standard deviation inversely to the above described (B). When a workaround action (operation) caused by a reboot or the like is performed, that point is defined as the “end point”. However, when the “performance problem occurrence state” is not recovered, a point at which the problem is recovered is defined as the “end point”.

As illustrated in FIG. 13B, data other than that of the “performance problem occurrence state” and the “symptom” are defined as data in a “normal state”. The data in the “normal state” can be represented with the following expression.

data in the “normal state”=performance data−(“performance problem occurrence state”+“symptom”)data

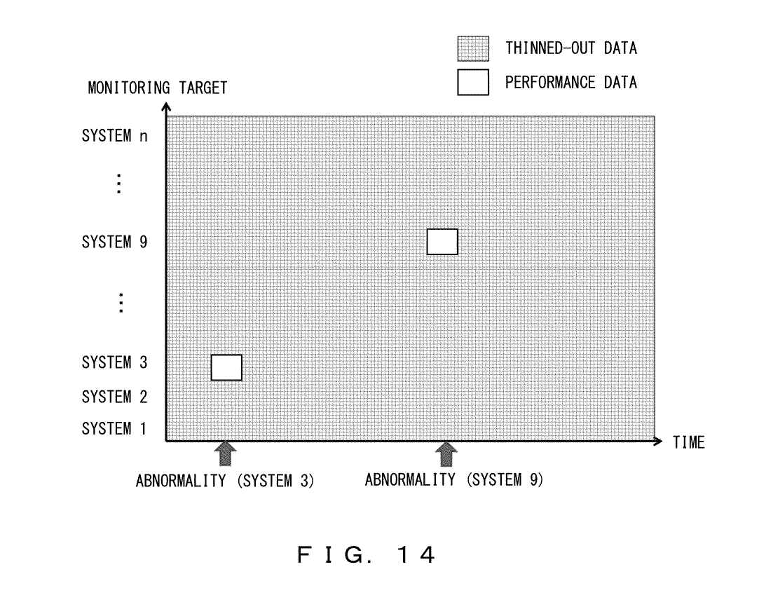

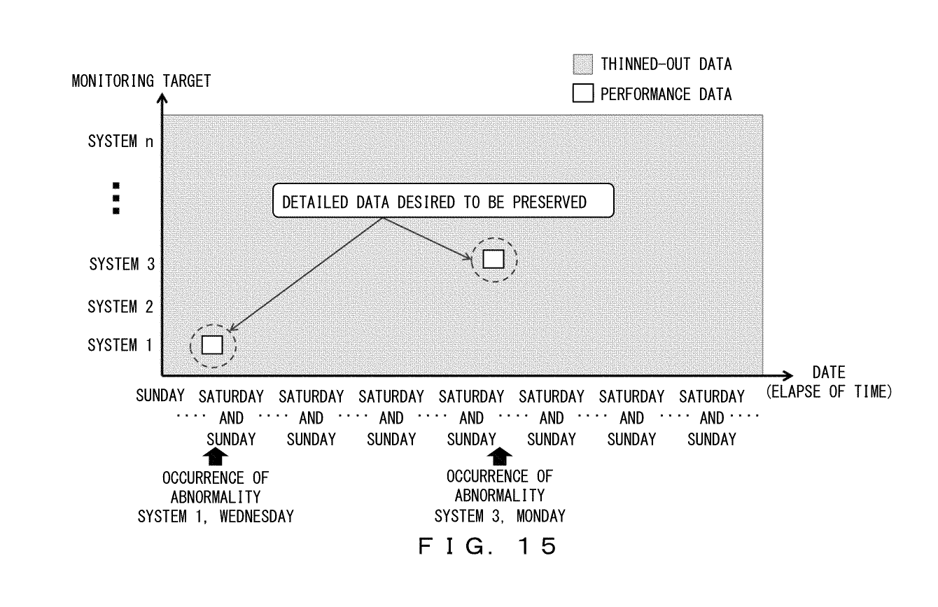

As illustrated in FIG. 13C, the thinning-out unit 20 thins out the data in the “normal state” from performance data. By thinning out the data in the normal state, data other than that in a time zone where an abnormality occurs can be properly thinned out in the business operation system as illustrated in FIGS. 14 and 15.

FIG. 14 illustrates results brought after the process for thinning out performance data to be monitored as time elapses, in this embodiment. A vertical axis indicates systems to be monitored, whereas a horizontal axis indicates time. Unlike FIG. 1, a “performance problem occurrence state” to be kept remains, and performance data that does not need to be kept is thinned out in FIG. 14.

FIG. 15 illustrates results brought after the process for thinning out performance data to be monitored as time elapses in units of weeks, in this embodiment. A vertical axis indicates systems to be monitored, whereas a horizontal axis indicates time. Unlike FIG. 2, performance data based on a periodical reboot is thinned out, and performance data based on a reboot other than a periodical reboot, namely, performance data based on a reboot performed when an abnormality occurs, remains.

According to this embodiment, a tendency of a performance transition can be referenced in accordance with past performance data, and is available for capacity management. Moreover, past performance data can be referenced when a cause of an occurrence of a performance problem is determined, whereby the cause can be easily determined.

A process for deleting unreferenced performance data is described next. As described above, only needed performance data (hereinafter referred to as “thinned-out performance data”) is preserved by thinning out data in a normal state from performance data accumulated in the performance information DB 22. However, preserved performance data increases if the data management is continuously performed. If thinned-out performance data that is not referenced for a long time is deleted, it does not matter.

Accordingly, thinned-out performance data may be deleted with a process, running at a fixed time every day, for deleting performance information, for example, when one year has elapsed since an immediately preceding reference date (a creation date if the data has not been referenced).

When target performance data is referenced with troubleshooting, not only related performance data (for example, also data of a memory and a disc are referenced even though a problem occurs in a CPU) but performance data of related computer and VMs within the system are referenced. By updating the reference date when the data is referenced, thinned-out performance data needed for the troubleshooting can be determined. Accordingly, if the thinned-out data that is not referenced is deleted when one year has elapsed, it does not matter.

Details of implementation examples of this embodiment are described next. A configuration of the system according to this embodiment is the same as that illustrated in FIG. 4. Values, used in the implementation examples to be described below, of a time, a length of time, a standard deviation, a data compression rate, and the like are merely examples for the sake of an explanation, and the values are not limited to these ones.

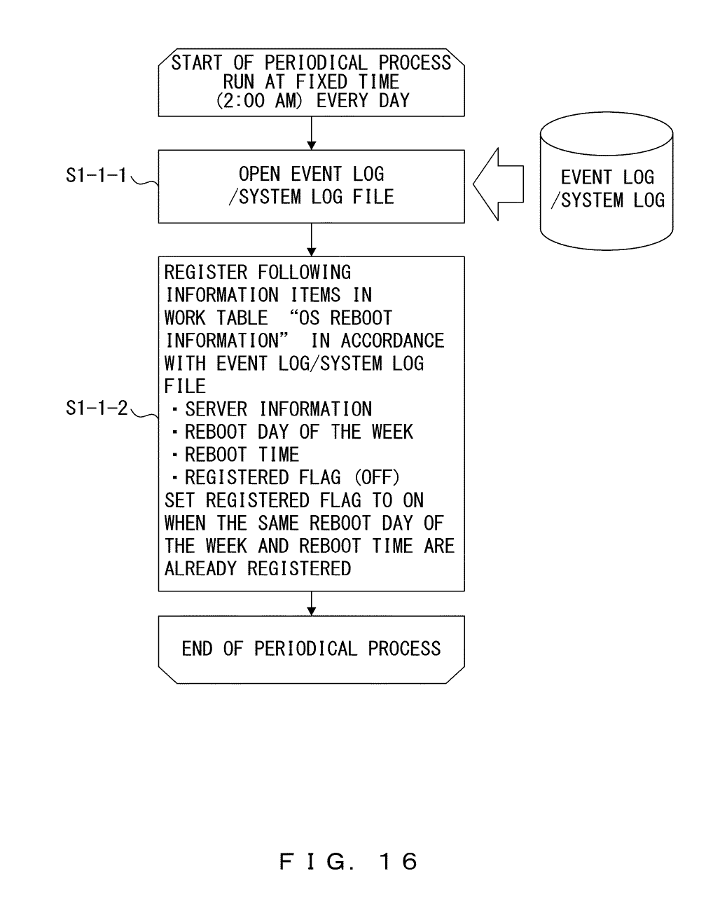

FIG. 16 illustrates details of a flow of the cycle information extraction (S1-1) (on the agent side) of a periodical OS reboot, in this embodiment. The agent processing unit 45 of the agent 44 installed in the host server 42 or the VM 43 executes the process of S1-1 at a fixed time (for example, 2:00 am) every day.

Initially, the agent processing unit 45 opens an event log/system log file (S1-1-1).

Next, the agent processing unit 45 extracts server information such as an IP address or the like, a reboot day of the week, and a reboot time from the event log/system log file, and registers the extracted information to the OS reboot information 31. The agent processing unit 45 further registers a registered flag (OFF) to the OS reboot information 31. However, when the same reboot day of the week and reboot time are already registered in the same server information, the agent processing unit 45 sets the registered flag (ON) in the OS reboot information 31.

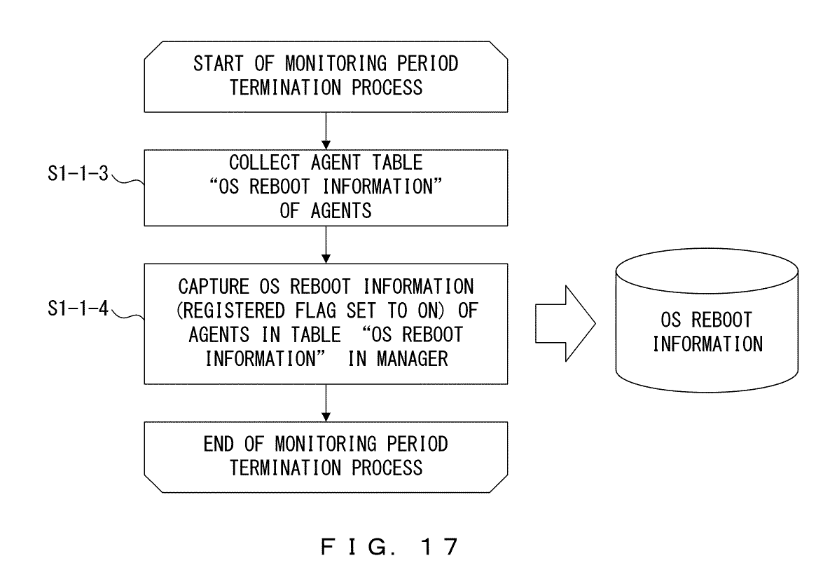

FIG. 17 illustrates details of a flow of the cycle information extraction (S1-1) (on the manager side) of a periodical OS reboot, in this embodiment. The manager 13 collects the OS reboot information 31 generated by each agent at the termination of the monitoring period (S1-1-3).

The manager 13 extracts the OS reboot information of the registered flag (ON) from the collected OS reboot information 31, and stores the extracted information in the management DB 23 as the OS reboot information 31 (S1-1-4).

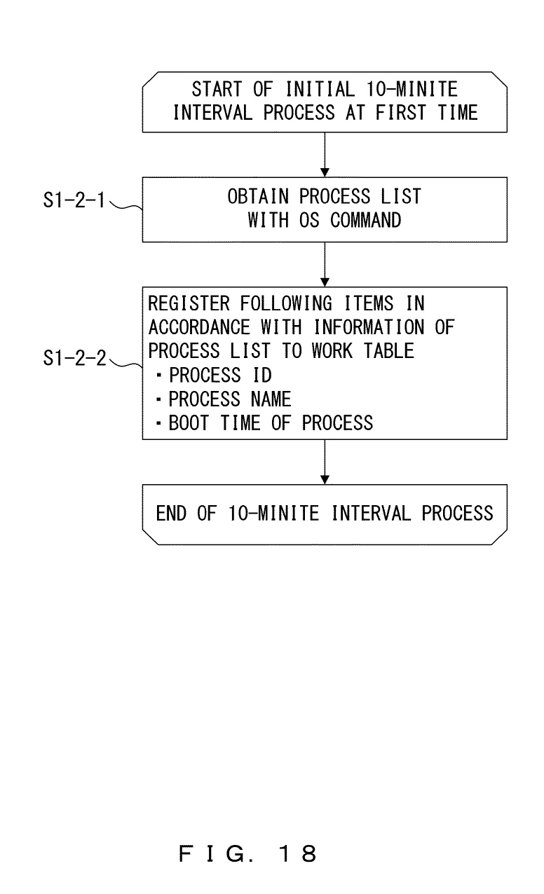

FIG. 18 illustrates details of a flow of the process, for the first time, (S1-2) (on the agent side) for extracting a stay-resident process list, in this embodiment. The agent processing unit 45 of the agent 44 installed in the host server 42 or the VM 43 executes the following process. Namely, when the agent processing unit 45 executes the process for extracting a stay-resident process list at specified time intervals (such as 10-minute intervals), the agent processing unit 45 obtains a process list by issuing a specified command to the OS, for the first time (S1-2-1).

The agent processing unit 45 extracts a “process ID”, a “process name”, and a “process boot time” from the obtained process list, and registers the extracted information to the stay-resident process list information (work table) 32a having an area secured in a memory of the host server 42 or the VM 43 (S1-2-2).

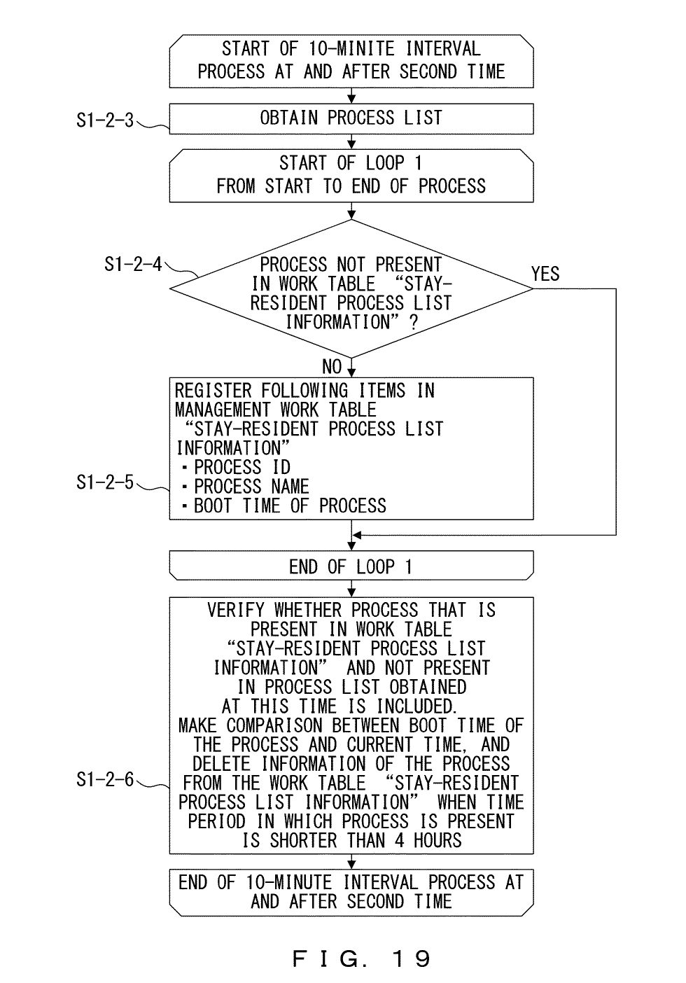

FIG. 19 illustrates details of the flow, at and after the second time, of the process (S1-2) for extracting a stay-resident process list, in this embodiment. The agent processing unit 45 obtains a process list by issuing a specified command to the OS installed in the host server 42 or the VM 43 in the process, executed at and after the second time, for extracting a stay-resident process list (S1-2-3).

The agent processing unit 45 obtains one process from the process list obtained in S1-2-3, and determines whether the obtained process is not registered in the stay-resident process list information (work table) 32a (S1-2-4).

When the obtained process is not registered in the stay-resident process list information (work table) 32a (“NO” in S1-2-4), the agent processing unit 45 performs the following operation. Namely, the agent processing unit 45 registers a “process ID”, a “process name”, and a “process boot time” of the obtained process in the stay-resident process list information (work table) 32a (S1-2-5).

The agent processing unit 45 repeats the operations of S1-2-4 to S1-2-5 for the number of processes included in the process list obtained in S1-2-3.

Next, the agent processing unit 45 verifies whether a process that is present in the stay-resident process list information (work table) 32a and not present in the process list obtained at this time is included. When the process that is present in the stay-resident process list information (work table) 32a and not present in the process list obtained at this time is included, the agent processing unit 45 makes a comparison between the boot time of the process and the current time. When the result of the comparison shows that the length of time since the process has been booted is shorter than four hours, the agent processing unit 45 deletes the information about the process from the stay-resident process list information (work table) 32a (S1-2-6).

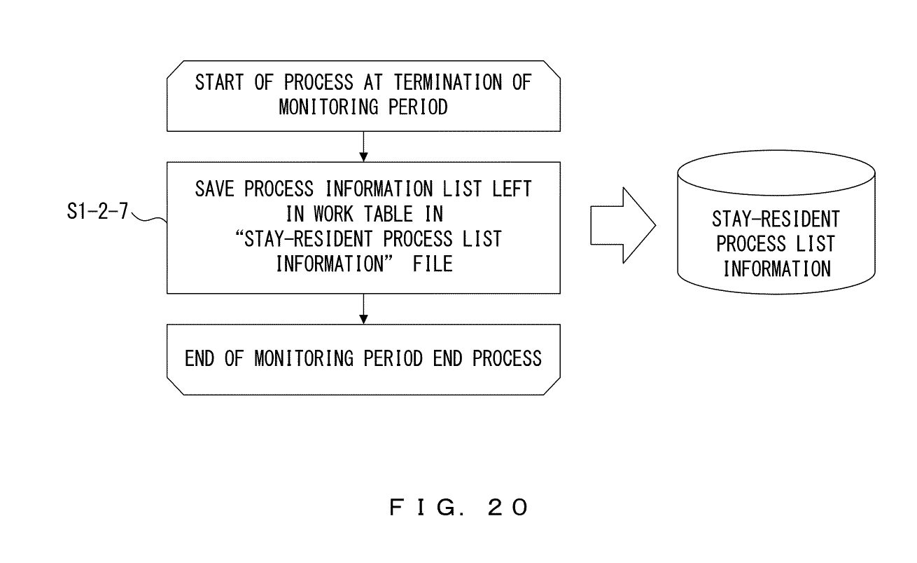

FIG. 20 illustrates details of the flow at the termination of the monitoring period of the process (S1-2) (on the manger side) for extracting a stay-resident process list, in this embodiment. The agent processing unit 45 transmits process information kept in the stay-resident process list information (work table) 32a to the manager 13.

The manager 13 receives the process information transmitted from each agent 44, and saves the information in a file as the stay-resident process list information 32 (S1-2-7).

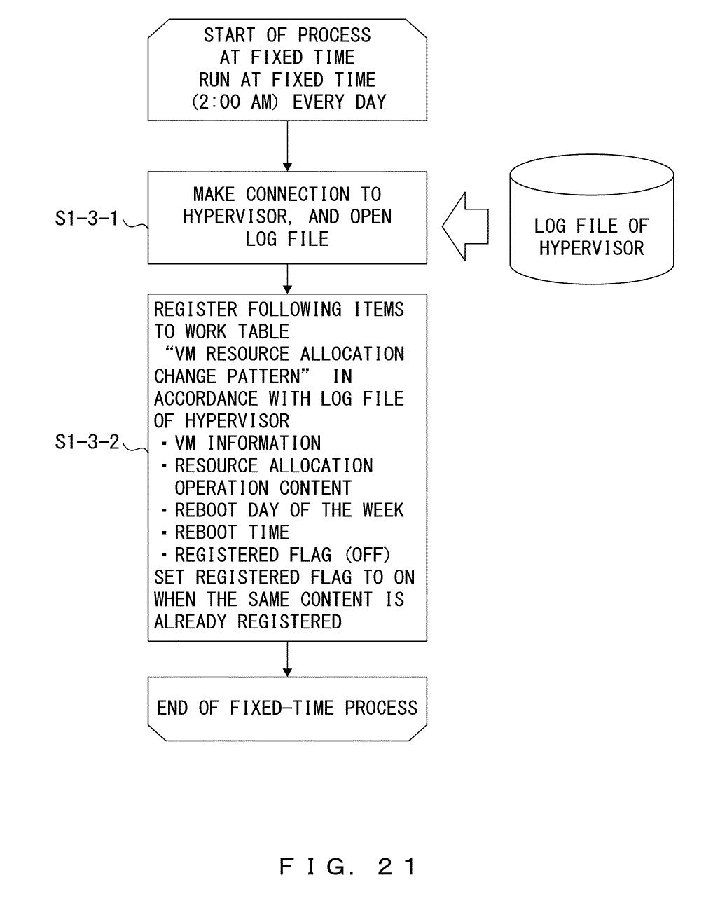

FIG. 21 illustrates details of a flow of the cycle information extraction (S1-3) (on the manager side) of a periodical dynamic change of a resource in a virtual environment, in this embodiment. The manager 13 executes the process of S1-3 at a fixed time (for example, 2:00 am) every day.

Initially, the manager 13 makes a connection to a hypervisor of each host server 42, and opens a log file of the hypervisor (S1-3-1).

The manager 13 extracts “VM information” for specifying a VM, a resource allocation operation content, a reboot day of the week, and a reboot time from the log file of the hypervisor, and registers the extracted information to the VM resource allocation change pattern (work table) 33a. The manager 13 further registers a registered flag (OFF) to the VM resource allocation change pattern (work table) 33a. However, when the same reboot day of the week and reboot time are already registered in the same server information, the manager 13 sets the registered flag (ON) in the VM resource allocation change pattern (work table) 33a (S1-3-2).

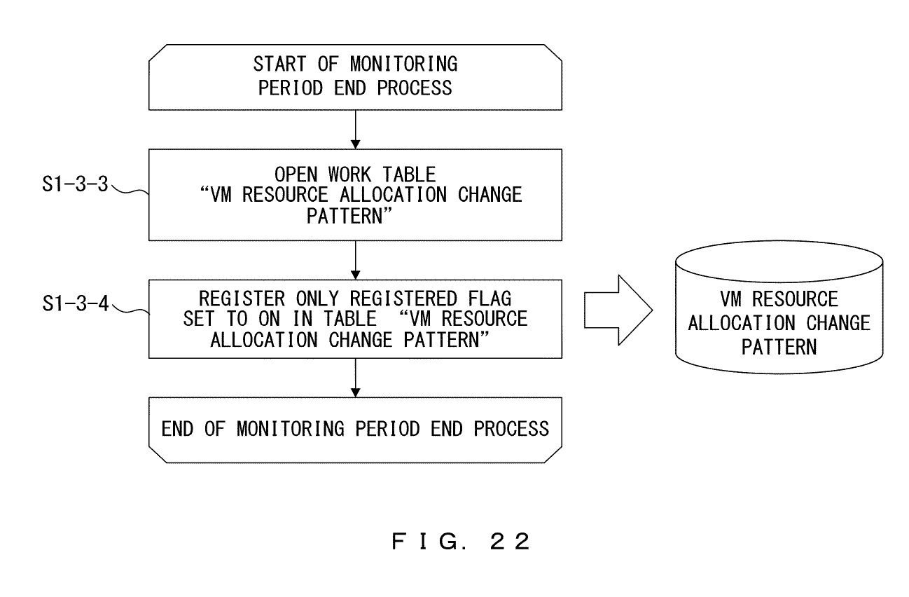

FIG. 22 illustrates details of the flow at the termination of the monitoring period of the cycle information extraction (S1-3) (on the manager side) of a periodical dynamic change of a resource in a virtual environment, in this embodiment. The manager 13 opens the VM resource allocation change pattern (work table) 33a (S1-3-3).

The manager 13 extracts the VM resource allocation change pattern including the registered flag (ON) from the VM resource allocation change pattern (work table) 33a, and stores the extracted pattern in the management DB 23 as the VM resource allocation change pattern 33 (S1-3-4).

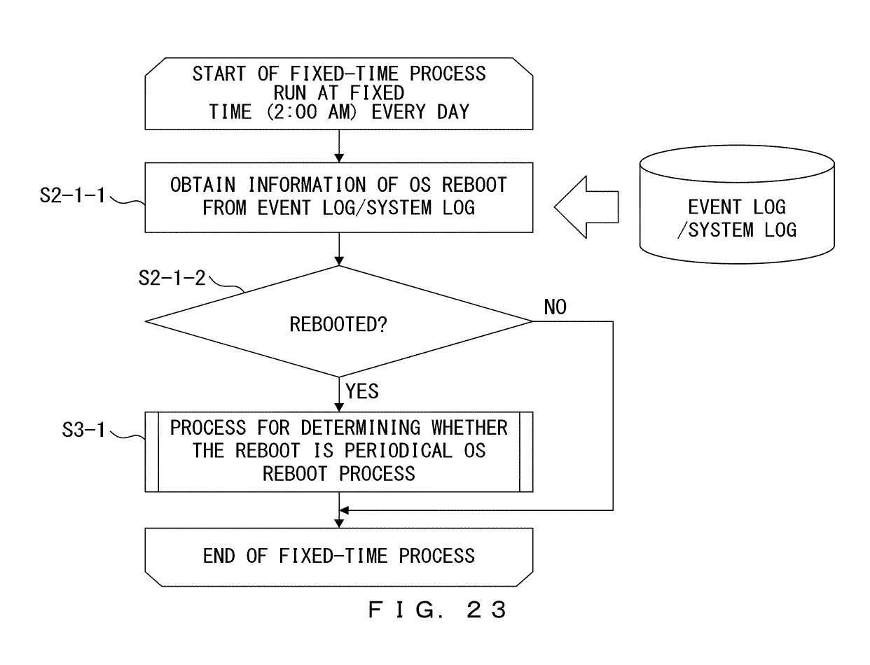

FIG. 23 illustrates details of a flow of the process (S2-1) for detecting an OS reboot, in this embodiment. The manager 13 obtains an event log/system log from each server at a fixed time (for example, 2:00 am) every day, and searches the obtained event log/system log for information of an OS reboot (S2-1-1).

When the information of the OS reboot is found in the obtained event log/system log (“YES” in S2-1-2), the manager 13 determines whether the found OS reboot is a periodical OS reboot process (S3-1).

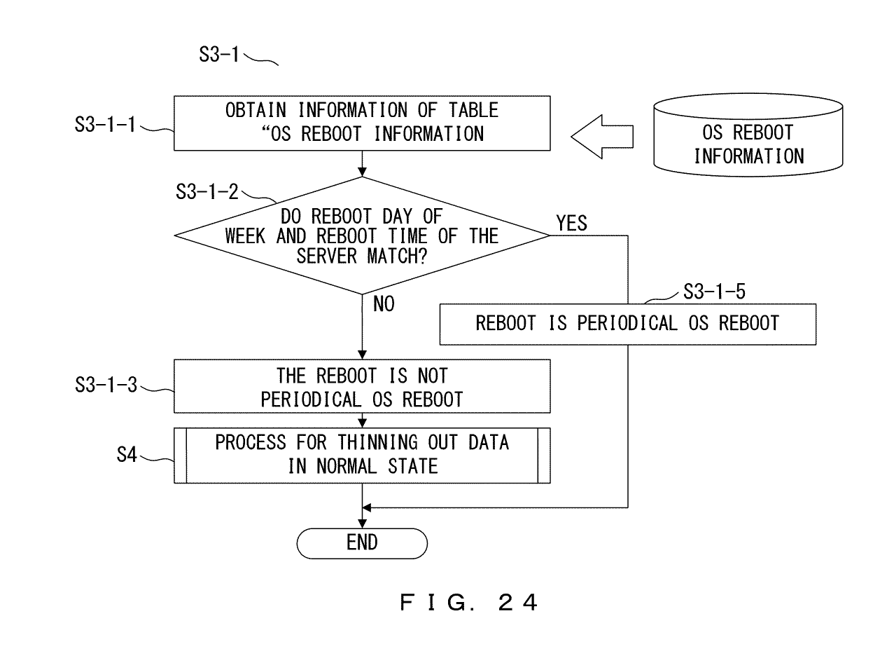

FIG. 24 illustrates details of a flow of the process (S3-1) for determining a periodical OS reboot, in this embodiment. The manager 13 obtains the OS reboot information 31 from the management DB 23, and determines whether information that matches the reboot day of the week and the reboot time of the found OS reboot is present in the OS reboot information 31 (S3-1-2). Here, it is assumed that a time difference of plus or minus one hour is recognized as a “match”.

When the information that matches the reboot day of the week and the reboot time of the found OS reboot is present in the OS reboot information 31 (“YES” in S3-1-2), the manager 13 determines that the found OS reboot is a periodical OS reboot process (S3-1-5).

When the information that matches the reboot day of the week and the reboot time of the found OS reboot is not present in the OS reboot information 31 (“NO” in S3-1-2), the manager 13 determines that the found OS reboot is not the periodical OS reboot process (S3-1-3). In this case, the manager 13 decides the found OS reboot as an operation to be excluded, and executes a process for thinning out performance data in a normal state from performance data stored in the performance information DB 22 (S4).

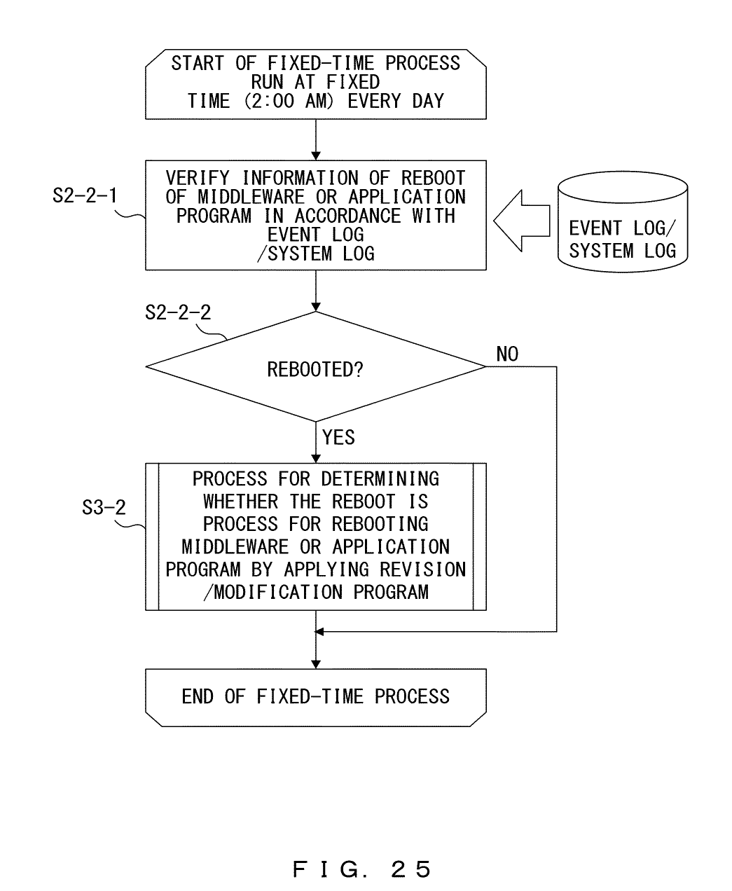

FIG. 25 illustrates details of a flow of the process (S2-2) for detecting a reboot of middleware or an application program, in this embodiment. The manager 13 obtains an event log/system log from each server at a fixed time (for example, 2:00 am) every day, and searches the obtained event log/system log for information of a reboot of middleware or an application program (S2-2-1).

When the information of the reboot of the middleware or the application is found in the event log/system log as a result of the search (“YES” in S2-2-2), the manager 13 executes the following process. Namely, the manager 13 determines whether the found reboot of the middleware or the application program is a process for rebooting the middleware or the application by applying a revision/modification program (S3-2).

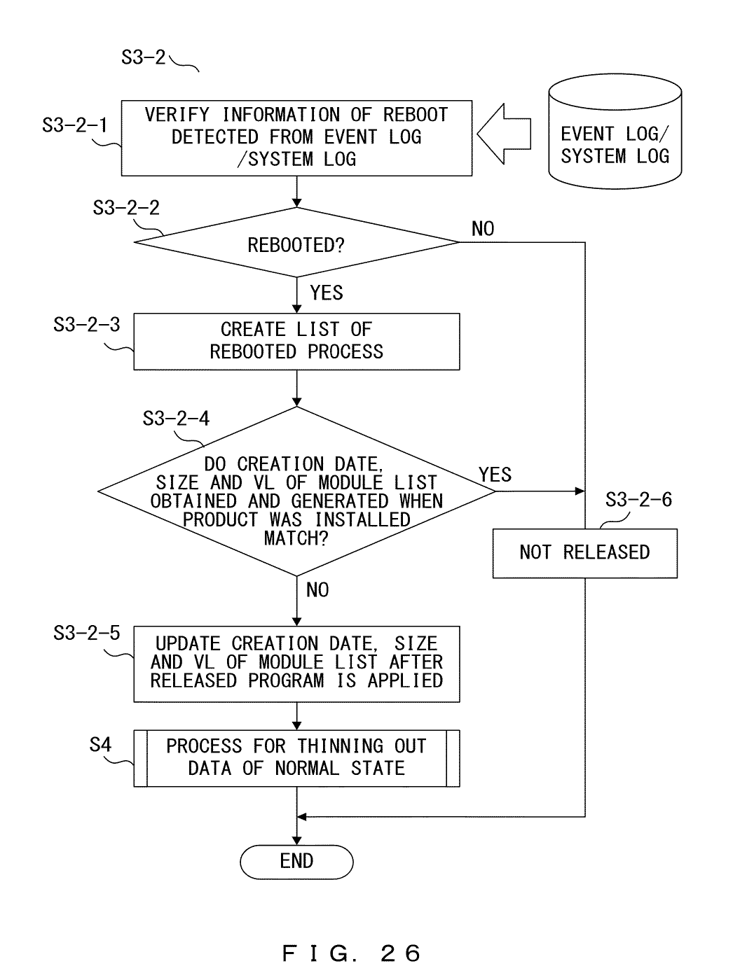

FIG. 26 illustrates details of a flow of the process (S3-2) for determining a reboot of middleware or an application program by applying a revision/modification program, in this embodiment. The manager 13 obtains an event log/system log, and determines whether middleware or an application program has been rebooted (S3-2-1).

When the middleware or the application program has not been rebooted (“NO” in S3-2-2), the manager 13 determines that the revision/modification program has not been released (S3-2-6), and terminates this flow.

When the middleware or the application program has been rebooted (“YES” in S3-2-2), the manager 13 creates the reboot process list 35 (FIG. 9) for the rebooted process from the event log/system log (S3-2-3).

The manager 13 makes a comparison between a creation date, a size and VL of the reboot process list 35 and those of the module list 36 (FIG. 10) created when the product was installed or the revision/modification program released at the preceding time was applied (S3-2-4). Here, it is assumed that a time difference of plus or minus one hour is recognized as a “match”.

When all the creation date, the size and the VL of the reboot process list 35 match those of the module list 36 (“YES” in S3-2-4), the manager 13 determines that the revision/modification program has not been released (S3-2-6), and terminates this flow.

When any of the creation date, the size and the VL of the reboot process list 35 mismatches that of the module list 36 (“NO” in S3-2-4), the manager 13 determines that the released revision/modification program is applied. In this case, the manager 13 updates, in the module list 36, the creation date, the size and the VL of the corresponding module to information obtained after the revision/modification program was applied (S3-2-5). The manager 13 decides the reboot of the process corresponding to the module that mismatches the module list 36 in the reboot process list 35 as an operation to be excluded, and executes a process for thinning out performance data in a normal state from performance data stored in the performance information DB 22 (S4).

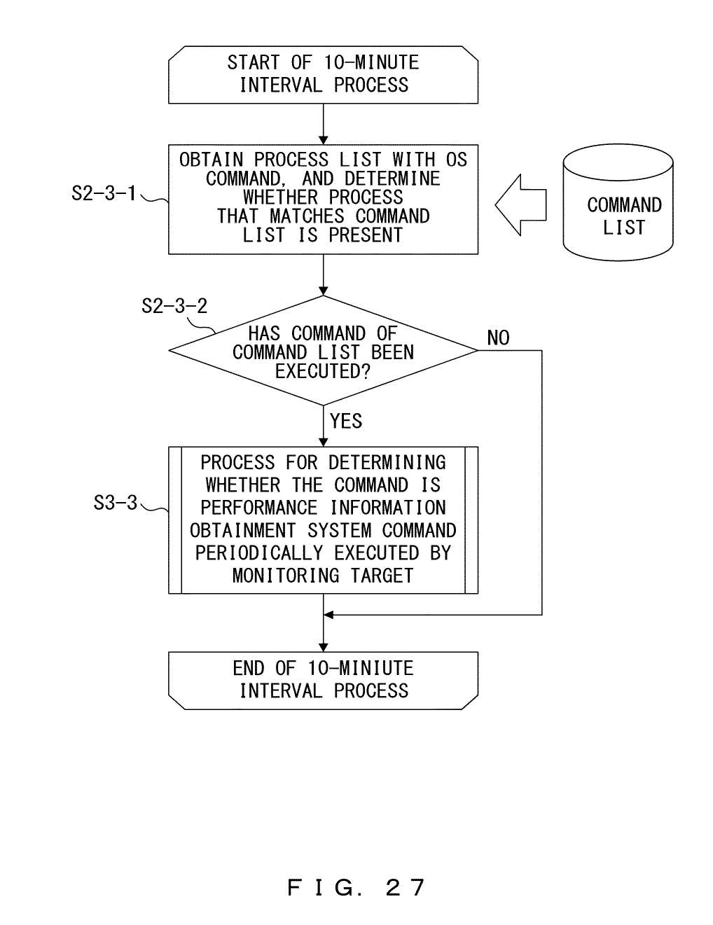

FIG. 27 illustrates details of a flow of the process (S2-3) for detecting a performance information obtainment system command periodically executed by a server to be monitored, in this embodiment. The manager 13 obtains a process list by issuing a specified command to an OS of the server to be monitored 41 at specified time intervals (for example, 10-minute intervals). The manager 13 determines whether a process that matches the command list 34 is present in the obtained process list (S2-3-1).

When the command (process) registered in the command list 34 is present in the obtained process list (“YES” in S2-3-2), the manager 13 executes the following process. Namely, the manager 13 executes a process for determining whether the command is a performance information obtainment system command periodically executed by the server to be monitored 41 (S3-3).

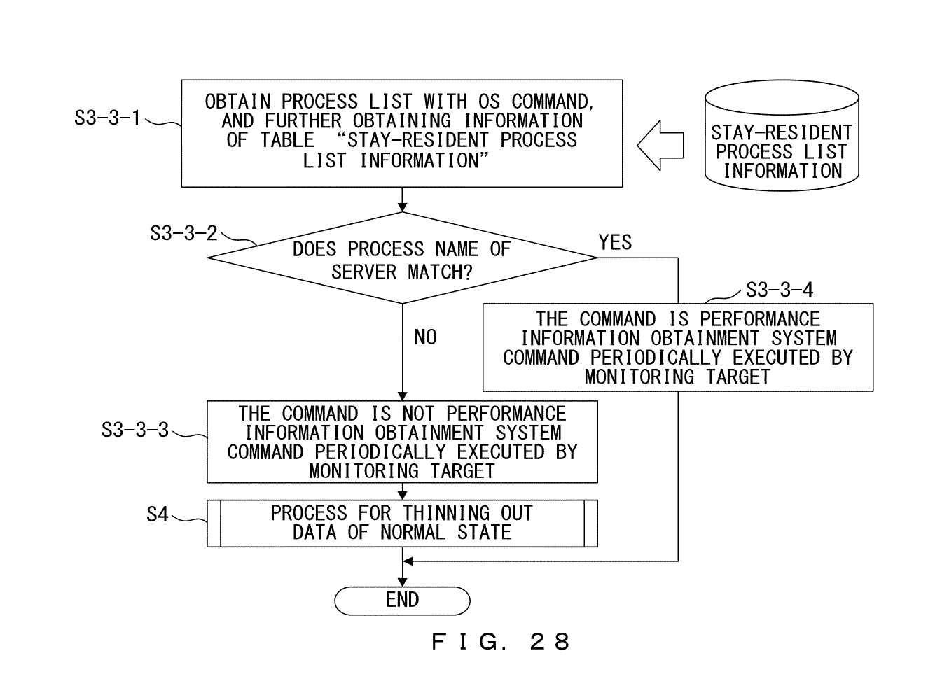

FIG. 28 illustrates details of a flow of the process (S3-3) for determining whether a command is a performance information obtainment system command periodically executed by the server to be monitored, in this embodiment. The manager 13 obtains a process list by issuing a specified command to an OS of the server to be monitored. The manager 13 makes a comparison between the obtained process list and the stay-resident process list information 32 stored in the management DB 23 (S3-3-1).

When a process name of the process list matches that of the stay-resident process list information 32 is present as a result of the comparison (“YES” in S3-3-2), the manager 13 determines that the command is a performance information obtainment system command periodically executed by the server to be monitored (S3-3-4).

When the process name of the process list that matches the stay-resident process list information 32 is not present as a result of the comparison (“NO” in S3-3-2), the manager 13 determines that the command is not the performance information obtainment system command periodically executed by the server to be monitored (S3-3-3). In this case, the manager 13 executes the process for thinning out performance data in a normal state from performance data stored in the performance information DB 22 (S4).

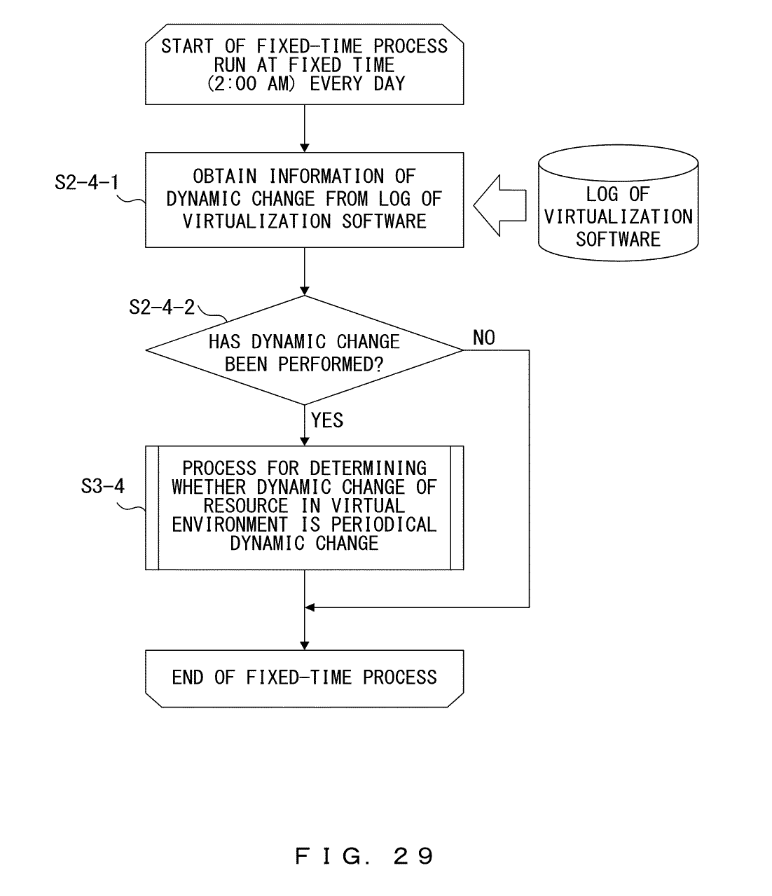

FIG. 29 illustrates details of a flow of the process (S2-4) for detecting a dynamic change of a resource in a virtual environment, in this embodiment. The manager 13 obtains information (VM resource allocation change information) about a dynamic change of a resource (a CPU or a memory) in a virtual environment from a log file of virtualization software installed in the server to be monitored 41, at a fixed time (for example, 2:00 am) every day. The manager 13 determines whether a dynamic change of a resource in the virtual environment has been performed, on the basis of the obtained VM resource allocation change information (S2-4-1).

When the dynamic change of the resource (the CPU or the memory) in the virtual environment has been performed (“YES” in S2-4-2), the manager 13 determines whether the dynamic change of the resource in the virtual environment is a periodical dynamic change (S3-4).

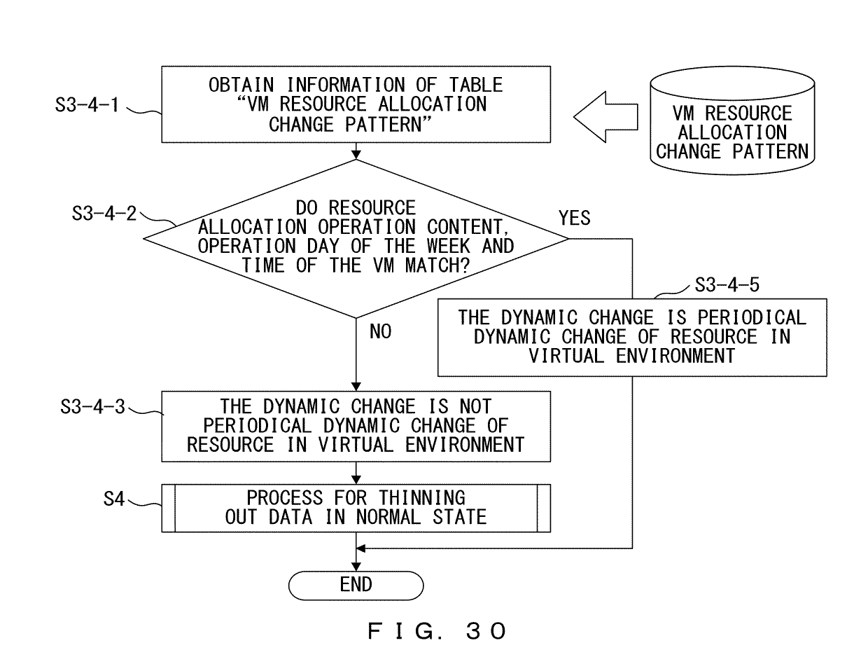

FIG. 30 illustrates details of a flow of the process (S3-4) for determining whether the dynamic change of the resource in the virtual environment is a periodical dynamic change, in this embodiment. The manager 13 obtains the VM resource allocation change pattern 33 from the management DB (S3-4-1).

The manager 13 determines whether information that matches a resource allocation operation content, an operation day of the week, and a time of a VM in VM resource allocation change information is present in the VM resource allocation change pattern 33 (S3-4-2). Here, it is assumed that a time difference of plus or minus one hour is recognized as a “match”.

When the information that matches the resource allocation operation content, the operation day of the week, and the time of the VM in which the dynamic change has been detected in S2-4-2 is present in the VM resource allocation change pattern 33 (“YES” in S3-4-2), the manager 13 executes the following process. Namely, the manager 13 determines that the dynamic change detected from the VM resource allocation change information is the periodical dynamic change of the resource in the virtual environment (S3-4-5).

When the information that matches the resource allocation operation content, the operation day of the week and the time of the VM in the VM resource allocation change information in which the dynamic change has been detected in S2-4-2 is not present in the VM resource allocation change pattern 33 (“NO” in S3-4-2), the manager 13 executes the following process. Namely, the manager 13 determines that the dynamic change detected from the VM resource allocation change information is not the periodical dynamic change of the resource in the virtual environment (S3-4-3). At this time, the manager 13 decides the dynamic change of the resource in the virtual environment detected in S2-4-2 as an operation to be excluded, and executes the process for thinning out performance data in a normal state from performance data stored in the performance information DB 22 (S4).

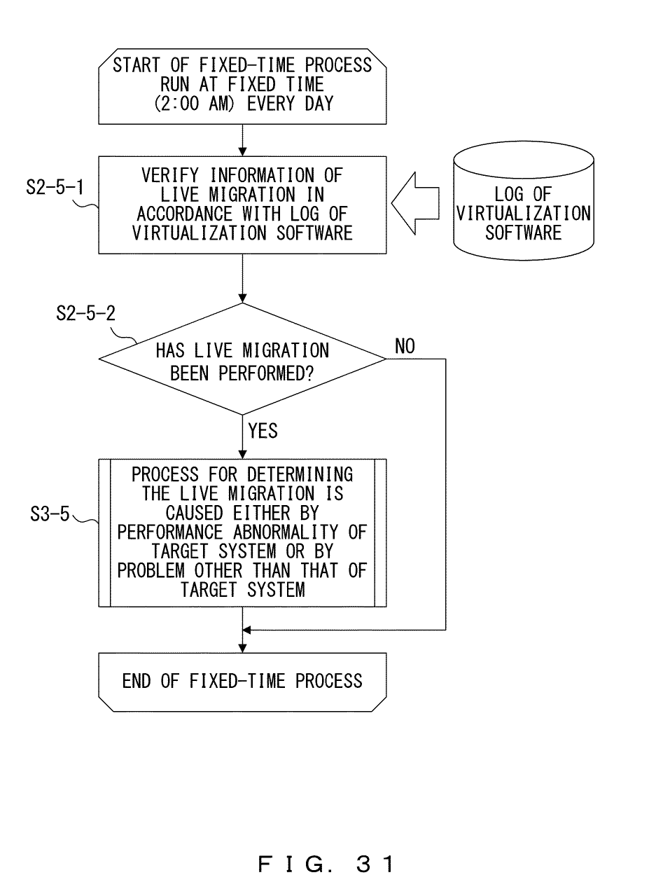

FIG. 31 illustrates details of a flow of the process (S2-5) for detecting a live migration in a virtual environment, in this embodiment. The manager 13 obtains information about a live migration from a log file of virtualization software installed in a business operation server at a fixed time (for example, 2:00 am) every day. The manager 13 determines whether the live migration has been performed, on the basis of the obtained information about the live migration (S2-5-1).

When the live migration has been performed (“YES” in S2-5-2), the manager 13 executes the following process. Namely, the manager 13 determines whether the live migration has been caused either by a performance abnormality of the target system or by a problem other than that of the target system (such as a performance abnormality of another system, maintenance or the like) (S3-5).

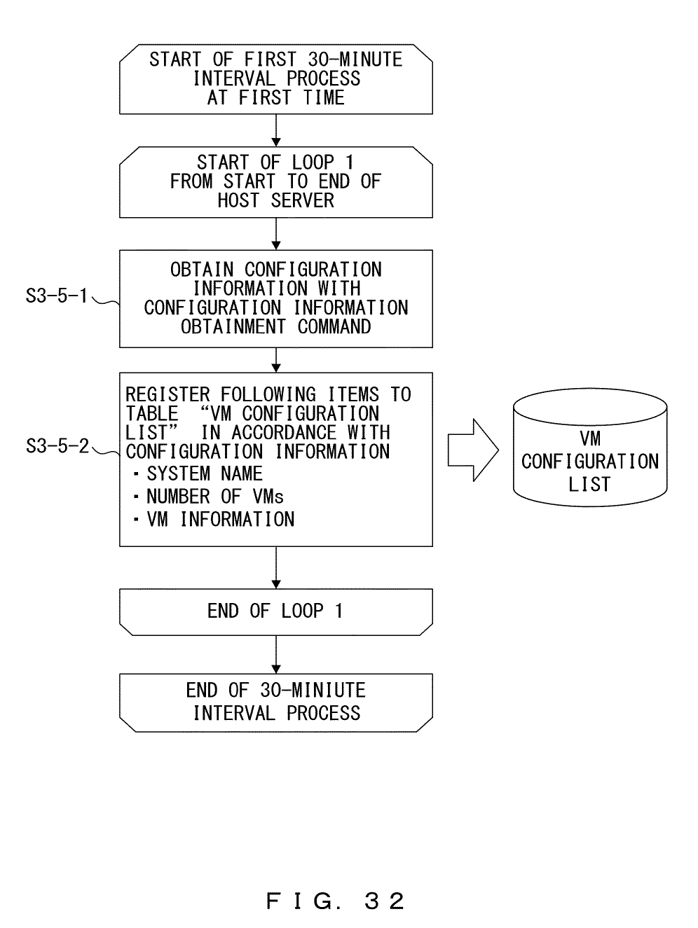

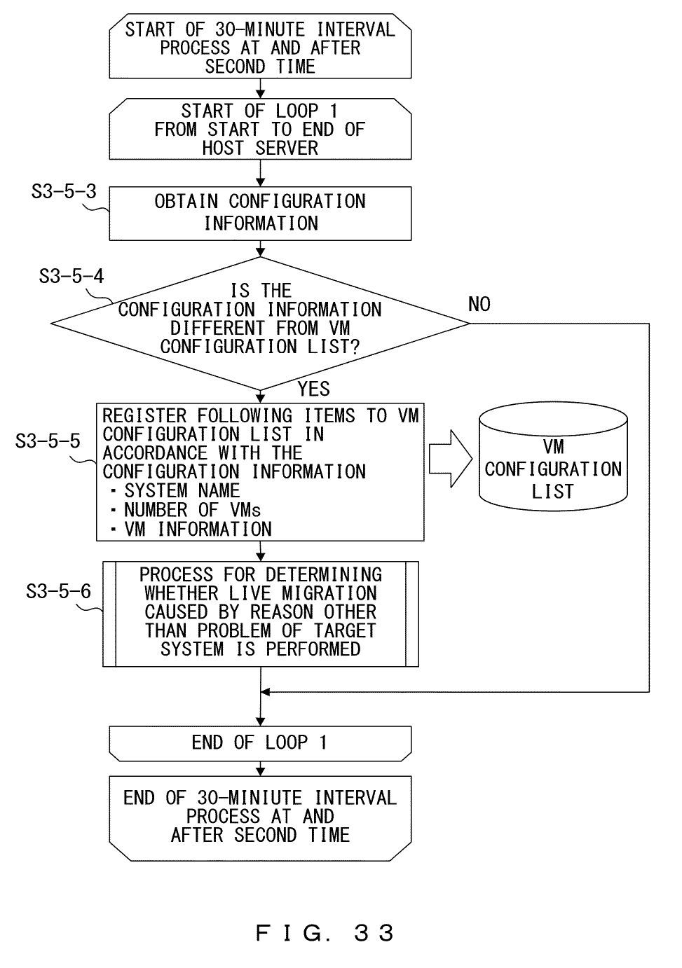

FIG. 32 illustrates details of a flow of the process (at the first time) (S3-4) for determining whether a live migration is caused by a problem other than that of a target system, in this embodiment. The manager 13 executes the process of FIG. 32 only at the first time among processes executed at specified time intervals (such as 30-minute intervals) for the virtualization software in each host server 42, and executes the process of FIG. 33 thereafter.

The manager 13 obtains configuration information from the host server 42 by issuing a configuration information obtainment command to the host server 42 (S3-5-1). The manager 13 extracts a system name, the number of VMs, and VM information from the obtained configuration information, and registers the extracted information to the VM configuration list 37 within the management DB 23 (S3-5-2).

The manager 13 repeats the process of S3-5-1 to S3-5-2 by the number of host servers 42.

FIG. 33 illustrates details of a flow of the process (at and after the second time) (S3-4) for determining whether the live migration is caused by a problem other than that of the target system, in this embodiment.

The manager 13 obtains configuration information from the host server 42 by issuing a configuration information obtainment command to the host server 42 (S3-5-3). The manager 13 makes a comparison between the configuration information obtained in S3-5-3 and the VM configuration list 37 within the management DB 23 (S3-5-4) (S3-5-4).

When the configuration information obtained in S3-5-3 is different from the VM configuration list 37 within the management DB 23 (“YES” in S3-5-4), the manager 13 extracts a system name, the number of VMs, and VM information from the configuration information obtained in S3-5-3. The manager 13 registers the extracted information to the VM configuration list 37 (S3-5-5).

The manager 13 executes a process for detecting whether a live migration caused by a reason other than a problem of the target system is present (S3-5-6).

The manager 13 repeats the process of S3-5-3 to S3-5-6 by the number of host servers 42.

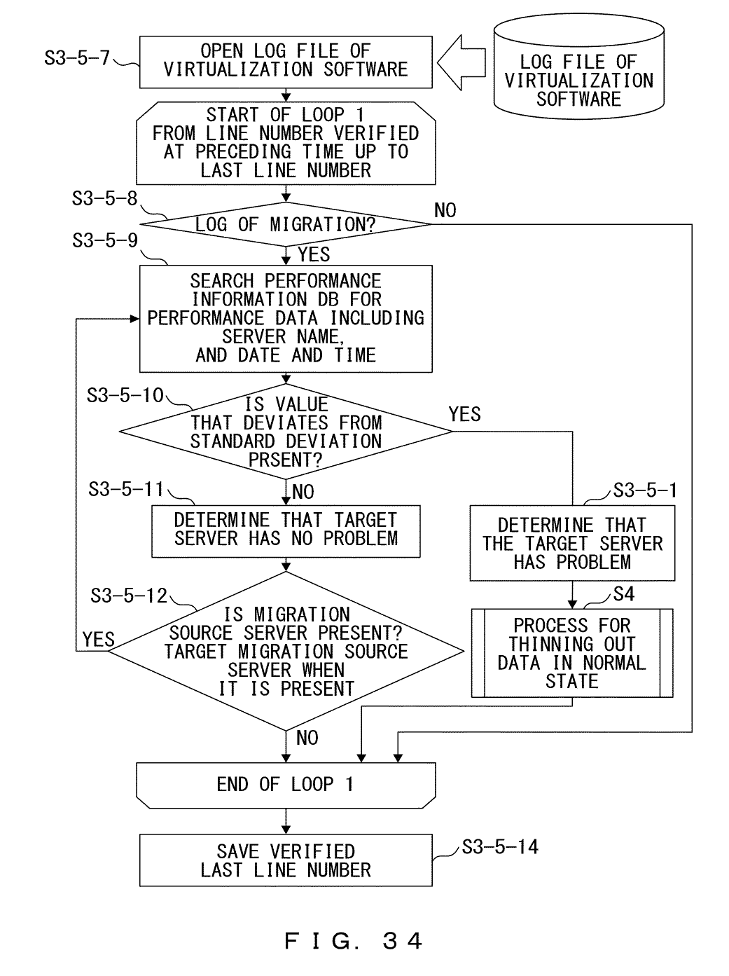

FIG. 34 illustrates details of a flow of the process (S3-5-6) for detecting whether a live migration caused by a reason other than a problem of a target system is present, in this embodiment.

The manager 13 accesses the host server 42 to open a log file of the virtualization software of the host server 42 (3-5-7).

The manager 13 obtains one log from the log file of the virtualization software of the host server 42, and determines whether the obtained log is a log of a migration (S3-5-8).

When the obtained log is the log of the migration (“YES” in S3-5-8), the manager 13 searches the performance information DB 22 for performance information data including a server name, and a date and time corresponding to those of the log (S3-5-9).

The manager 13 determines whether a value that deviates from a standard deviation is present during 12 hours preceding the date and time of the log for the performance information data obtained as a result of the search performed in S3-5-9 (S3-5-10).

When the value that deviates from the standard deviation is present during the 12 hours preceding the date and time in the performance information data (“YES” in S3-5-10), the manager 13 determines that a problem has occurred in the server to be monitored 41 (S3-5-13). At this time, the manager 13 decides the detected migration operation as an operation to be excluded, and executes the process for thinning out performance data in a normal state from performance data stored in the performance information DB 22 (S4).

When the value that deviates from the standard deviation is not present during the 12 hours preceding the date and time of the log for the performance information data obtained as a result of the search performed in S3-5-9 (“NO” in S3-5-10), the manager 13 determines that a problem has not occurred in the server to be monitored 41 (S3-5-11). In this case, the manager 13 determines whether a migration source server is present (S3-5-12).

When the migration source server is present (“YES” in S3-5-12), the manager 13 recognizes the migration source server as a target server, and executes the process of S3-5-9. When the migration source server is not present (“NO” in S3-5-12), the manager 13 obtains the next log from the log file of the virtualization software, and executes the process of S3-5-8 and subsequent process steps.

The manager 13 repeats the process of S3-5-8 to S3-5-13 and S4 from the line number verified at the preceding time to the last line number. Thereafter, the manager 13 saves the verified last line number in the log file of the virtualization software (S3-5-14).

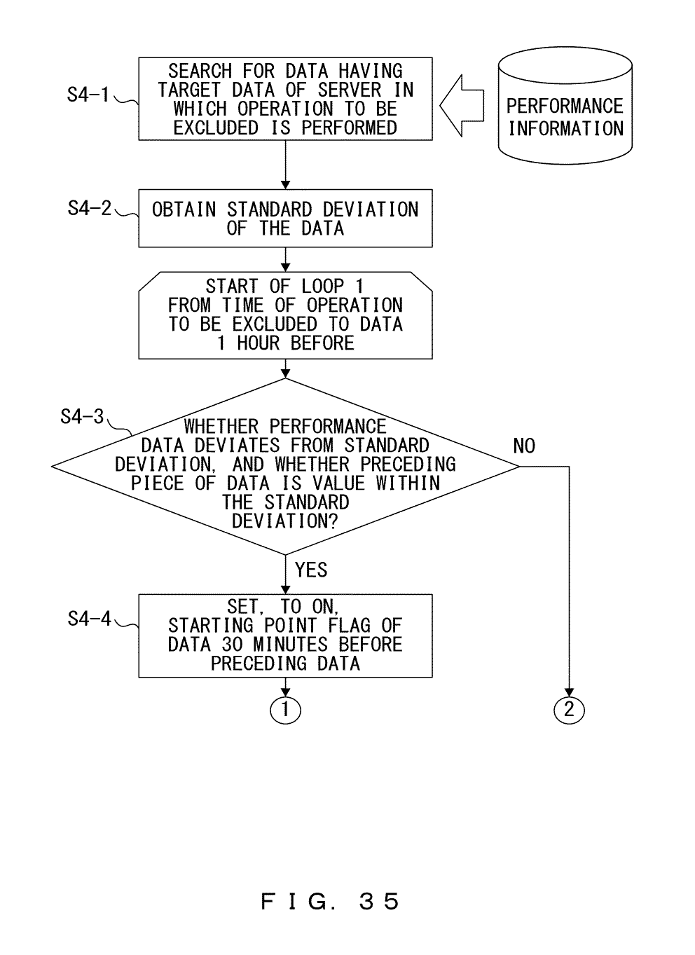

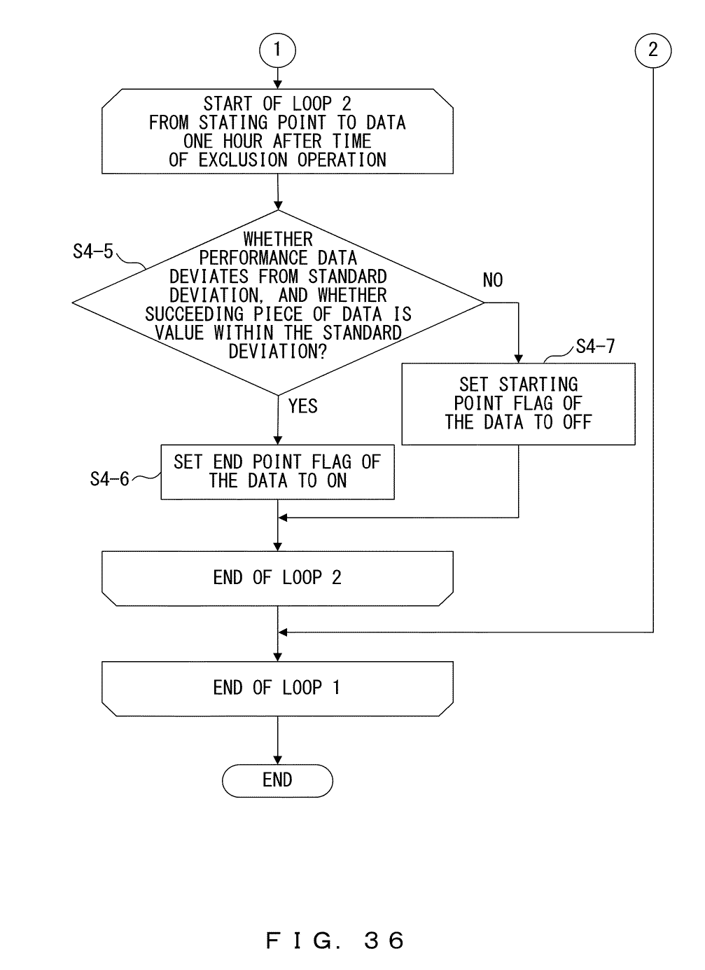

FIGS. 35 and 36 illustrate details of a flow of a process for specifying a starting point and an end point of a time period in which performance data deviates from a range of a standard deviation in the process (S4) for thinning out performance data in a normal state from performance data stored in the performance information DB 22, in this embodiment.

The manager 13 searches the performance information DB 22 for performance data having a target date and time of a server, in which an operation to be excluded is performed, by using the server name and the date as a key (S4-1).

The manager 13 calculates a standard deviation of the performance value of the searched performance data (S4-2). For example, when the performance data is a CPU use rate, an average μ and the standard deviation σ of the CPU use rate with respect to time are calculated as illustrated in FIG. 13A, and (μ−σ≦“average value μ±standard deviation σ”≦μ+σ)=10 to 20 percent is assumed to be obtained.

The manager 13 determines whether the performance data deviates from the range of μ±σ (μ−σ≦average value±μ+σ) by going back to the past for each of entries of the performance data, and whether a preceding piece of data is a value within the standard deviation (S4-3).

When the performance data deviates from the range of μ±σ and the preceding piece of data is the value within μ±σ (“YES” in S4-3), the manager 13 sets, to ON, a starting point flag of data a specified length of time (such as 30 minutes) before the time of the performance data (S4-4).

When the performance data does not deviate from the range of μ±σ or the preceding piece of data is not the value within μ±σ (“NO” in S4-3), the manager 13 executes the process of S4-3 for performance data at a succeeding time.

Then, the manager 13 determines whether the performance data deviates from μ±σ, and whether the preceding piece of data is a value within μ±σ (S4-5).

When the performance data deviates from μ±σ and the preceding piece of data is the value within μ±σ (“YES” in S4-5), the manager 13 sets, to ON, the end flag of the performance data (S4-6).

When the performance data does not deviate from μ±σ and the preceding piece of data is not the value within μ±σ (“NO” in S4-5), the manager 13 sets, to OFF, an endpoint flag of the performance data (S4-6).

The manager 13 repeats the process of S4-5 to S4-7 from the starting point to data a specified length of time (for example, one hour) after the time of the operation to be excluded.

The manager 13 repeats the process of S4-5 to S4-7 from the starting point to data the specified length of time (for example, one hour) after the time of the operation to be excluded.

Additionally, the manager 13 repeats the process of S4-3 to S4-7 from the time of the operation to be excluded to the data the specified length of time (for example, one hour) after the time of the operation to be excluded.

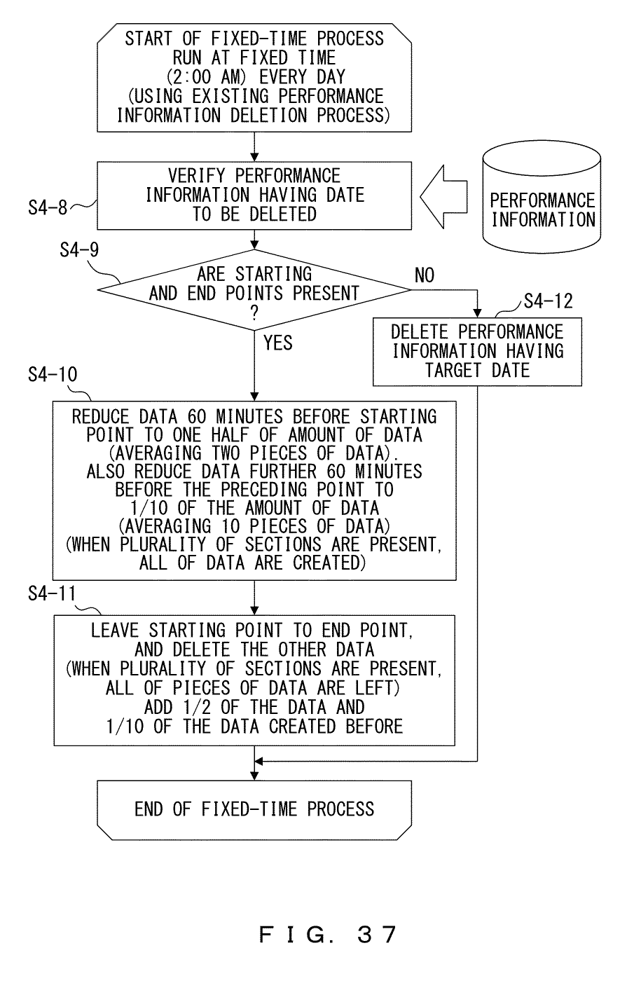

FIG. 37 illustrates details of a flow of the process (S4) for thinning out performance data in a normal state from performance data stored in the performance information DB 22 on the basis of specified starting point and end point. The manager 13 executes the process represented by this flow at a fixed time (for example, 2:00 am) every day.

The manager 13 obtains performance data having a date to be deleted from the performance information DB 22 (S4-8). When the obtained performance data does not have a starting point and an end point (“NO” in S4-9), the manager 13 deletes the performance data having the date (S4-12).

When the obtained performance data includes a section indicated by a starting point and an endpoint (“YES” in S4-9), the manager 13 reduces, as symptom data, data a specified length of time (for example, 60 minutes) before the starting point to one half of the amount of data (averages values of two pieces of data). Moreover, the manager 13 reduces, as symptom data, the data the specified length of time (for example, 60 minutes) further before the preceding data to one tenth of the amount of data (averages values of 10 pieces of data). When the obtained performance data includes a plurality of sections respectively indicated by a starting point and an end point, the manager 13 executes the process of S4-10 for each of the sections.

The manager 13 leaves performance data in each section from the starting point to the end point, and deletes the rest of the performance data. The manager 132 adds the symptom data created in S4-10 to the kept performance data (S4-11).

A process for deleting thinned-out performance data after a specified length of time elapses from an immediately preceding reference date (creation data if performance data is not referenced) by using the process, executed at a fixed time every day, for deleting performance information is described next.

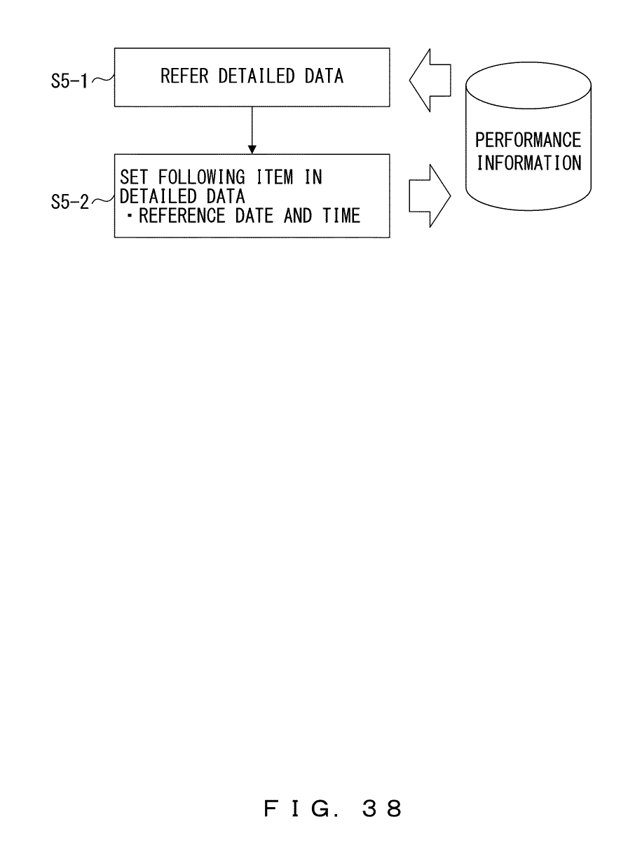

FIG. 38 illustrates a flow of a process for referencing performance data, in this embodiment. The manager 13 references performance information in the performance information DB 22 (S5-1). In this case, the manager 13 sets a reference date and time in the referenced performance data (S5-2).

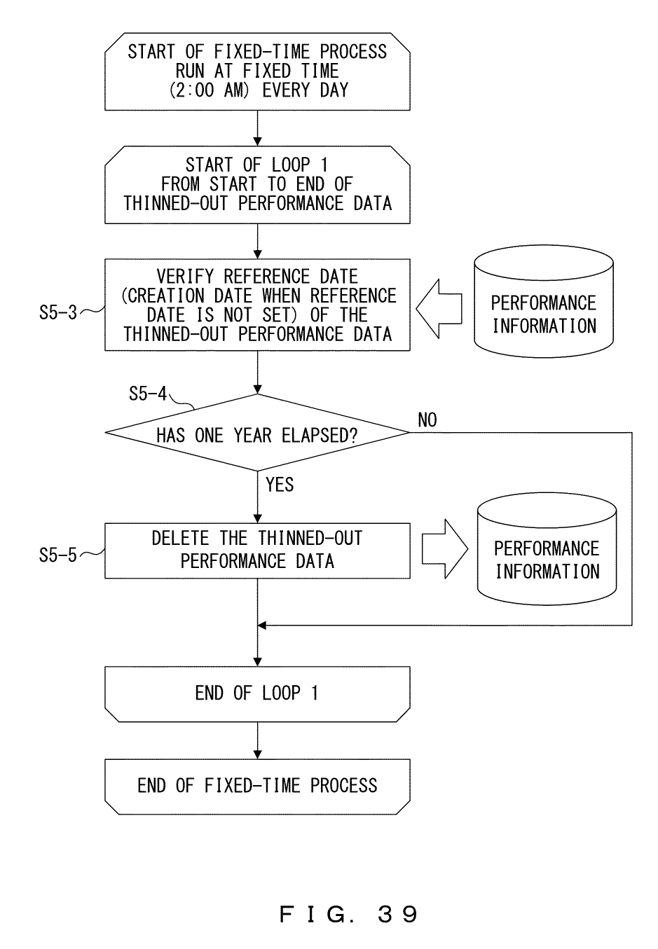

FIG. 39 illustrates a flow of the process for deleting unreferenced performance data, in this embodiment. The manager 13 executes the process represented by this flow at a fixed time (for example, 2:00 am) every day.

The manager 13 references a reference date and time (a creation date and time of performance data when a reference date and time is not set) of thinned-out performance data in the performance information DB 22 (S5-3), and determines whether a specified time period (for example, one year) has elapsed since the reference date and time (S5-4).

When the specified time period (for example, one year) has elapsed since the reference date and time (“YES” in S5-4), the manager 13 deletes the thinned-out performance data from the performance information DB 22 (S5-5).

The manager executes the process of S5-3 to S5-5 respectively for pieces of thinned-out performance data stored in the performance information DB 22.

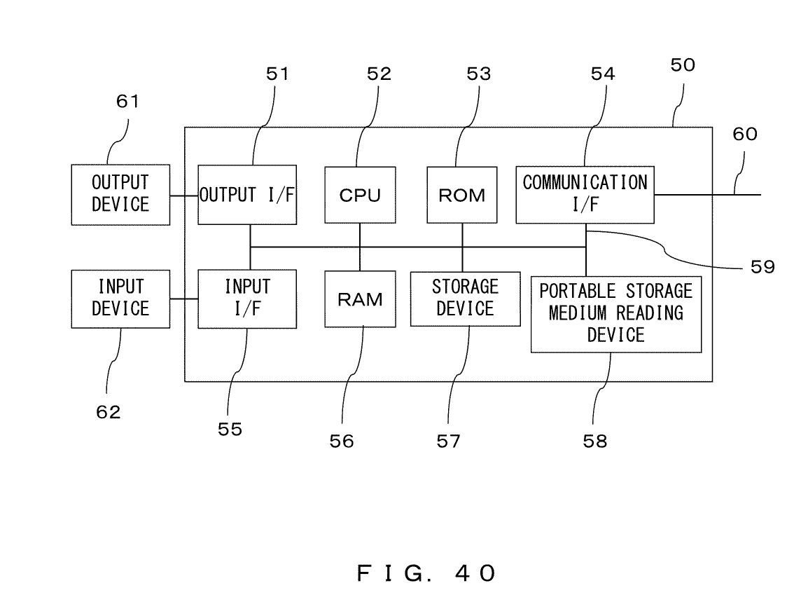

FIG. 40 illustrates an example of a configuration block diagram of a hardware environment of a computer that executes a program according to this embodiment. The computer 50 functions as the management server 11. The computer 50 is configured by including a CPU 52, a ROM 53, a RAM 56, a communication I/F 54, a storage device 57, an output I/F 51, an input I/F 55, a reading device 58, a bus 59, an output device 61, and an input device 62.

Here, the CPU stands for a central processing unit. The ROM stands for a read only memory. The RAM stands for a random access memory. The I/F stands for an interface. To the bus 59, the CPU 52, the ROM 53, the RAM 56, the communication I/F 54, the storage device 57, the output I/F 51, the input I/F 55, and the reading device 58 are connected. The reading device 58 is a device that reads a portable recording medium. The output device 61 is connected to the output I/F 51. The input device 62 is connected to the input I/F 55.

As the storage device 57, various forms of storage devices such as a hard disk, a flash memory, a magnetic disc and the like are available. In the storage device 57 or the ROM 53, a program of monitoring software (manager) that causes the CPU 52 to function as the display control unit 14, the collection unit 15, the accumulation control unit 16, the extraction unit 17, the detection unit 18, the decision unit 19, and the thinning-out unit 20 is stored. Moreover, the performance information DB 22 and the management DB 23 are stored in the storage device 57 or the ROM 53. In the RAM 56, information is temporarily stored.

The CPU 52 reads the program of the monitoring software (manager), and executes the program.

The program that implements the processes described in the aforementioned embodiment may be stored, for example, in the storage device 57 by being provided from a program provider side via a communication network 60 and the communication I/F 54. Moreover, the program that implements the processes described in the aforementioned embodiment may be stored on a portable storage medium that is marketed and distributed. In this case, the portable storage medium may be set in the reading device 58, and the program stored on the portable storage medium may be read and executed by the CPU 52. As the portable storage medium, various forms of storage media such as a CD-ROM, a flexible disc, an optical disc, a magneto-optical disc, an IC card, a USB memory device and the like are available. The program stored on such storage media is read by the reading device 58.

Additionally, as the input device 62, a keyboard, a mouse, an electronic camera, a web camera, a microphone, a scanner, a sensor, a tablet or the like is available. As the output device 61, a display, a printer, a speaker or the like is available. Furthermore, the communication network 60 may be a communication network such as the Internet, a LAN, a WAN, a dedicated line network, a wired or wireless communication network, or the like.

According to an aspect of the present invention, a log corresponding to a time period in which an abnormality occurs can be extracted from an accumulated log to be monitored.

The present invention is not limited to the above described embodiment, and can take various configurations or embodiments within a scope that does not depart from the gist of the present invention.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a data management program for causing a computer to execute a process comprising:
obtaining first operation information about a specified operation from an information processing apparatus;
specifying second operation information that matches a registered operation pattern from the first operation information, by utilizing operation pattern information that includes correspondence information between the specified operation and the registered operation pattern, the operation pattern information being stored in a first memory;
obtaining a second log from a first log of the information processing apparatus, the second log corresponds to time periods in which the specified operations that are not permitted by the registered operation pattern are done, the first log being stored in a second memory; and
specifying a time period of a log extracted on the basis of a performance value indicated by the second log.

2. The non-transitory computer-readable recording medium according to claim 1, wherein
the specifying a time period specifies a log of a time period in which the performance value indicated by the obtained second log deviates from a specified range.

3. The non-transitory computer-readable recording medium according to claim 2, wherein
the obtaining a second log obtains, from the second memory, the second log that matches a date on which the unpermitted second operation information is registered in the registered operation pattern, and
the specifying a time period calculates a standard deviation of the performance value indicated by the obtained second log, and specifies the log corresponding to the time period in which the performance value deviates from the standard deviation.

4. The non-transitory computer-readable recording medium according to claim 3, wherein
the specifying a time period calculates an average of the performance value of a log present for a specified length of time before the time period in which the performance value deviates from a range of the standard deviation, and specifies a log of the averaged performance value.

5. The non-transitory computer-readable recording medium according to claim 1, wherein
the operation pattern information is pattern information about a reboot of a specified program in the information processing apparatus, a specified command issued to the information processing apparatus, a change of a resource in the information processing apparatus, or a migration of a virtual environment of a virtual machine in a case where the information processing apparatus is the virtual machine.

6. A data management apparatus comprising:
a first memory;
a second memory; and
a processor that executes a process including:
obtaining first operation information about a specified operation from an information processing apparatus;
specifying second operation information that matches a registered operation pattern from the first operation information, by utilizing operation pattern information that includes correspondence information between the specified operation and the registered operation pattern, the operation pattern information being stored in a first memory;
obtaining a second log from a first log of the information processing apparatus, the second log corresponds to time periods in which the specified operations that are not permitted by the registered operation pattern are done, the first log being stored in a second memory; and
specifying a time period of a log extracted on the basis of a performance value indicated by the second log.

7. The data management apparatus according to claim 6, wherein
the specifying a time period specifies a log of a time period in which the performance value indicated by the obtained second log deviates from a specified range.

8. The data management apparatus according to claim 7, wherein
the obtaining a second log obtains, from the second memory, the second log that matches a date on which the unpermitted second operation information is registered in the registered operation pattern, and
the specifying a time period calculates a standard deviation of the performance value indicated by the obtained second log, and specifies the log corresponding to the time period in which the performance value deviates from the standard deviation.

9. The data management apparatus according to claim 8, wherein
the specifying a time period calculates an average of the performance value of a log present for a specified length of time before the time period in which the performance value deviates from the range of the standard deviation, and specifies a log of the averaged performance value.

10. The data management apparatus according to claim 6, wherein
the operation pattern information is pattern information about a reboot of a specified program in the information processing apparatus, a specified command issued to the information processing apparatus, a change of a resource in the information processing apparatus, or a migration of a virtual environment of a virtual machine in a case where the information processing apparatus is the virtual machine.

11. A data management method comprising:
obtaining operation information about a specified operation from an information processing apparatus by using the computer;
obtaining first operation information about a specified operation from an information processing apparatus;
specifying second operation information that matches a registered operation pattern from the first operation information, by utilizing operation pattern information that includes correspondence information between the specified operation and the registered operation pattern, the operation pattern information being stored in a first memory;
obtaining a second log from a first log of the information processing apparatus, the second log corresponds to time periods in which the specified operations that are not permitted by the registered operation pattern are done, the first log being stored in a second memory; and
specifying a time period of a log extracted on the basis of a performance value indicated by the second log.

12. The data management method according to claim 11, wherein
the specifying a time period specifies a log of a time period in which the performance value indicated by the obtained second log deviates from a specified range.

13. The data management method according to claim 12, wherein
the obtaining a second log obtains, from the second memory, the second log that matches a date on which the unpermitted second operation information is registered in the registered operation pattern, and
the specifying a time period calculates a standard deviation of the performance value indicated by the obtained second log, and specifies the log corresponding to the time period in which the performance value deviates from the standard deviation.

14. The data management method according to claim 13, wherein
the specifying a time period calculates an average of the performance value of a log present for a specified length of time before the time period in which the performance value deviates from a range of the standard deviation, and specifies a log of the averaged performance value.

15. The data management method according to claim 11, wherein
the operation pattern information is pattern information about a reboot of a specified program in the information processing apparatus, a specified command issued to the information processing apparatus, a change of a resource in the information processing apparatus, or a migration of a virtual environment of a virtual machine in a case where the information processing apparatus is the virtual machine.
